(19) United States
(12) Patent Application Publication
(10) Pub. No.: US 2023/0198008 A1
(43) Pub. Date: Jun. 22, 2023

(54) SECONDARY BATTERY, AND VEHICLE INCLUDING SECONDARY BATTERY

(71) Applicant: SEMICONDUCTOR ENERGY LABORATORY CO., LTD., Atsugi-shi, Kanagawa-ken (JP)

(72) Inventors: Shunpei YAMAZAKI, Setagaya, Tokyo (JP); Yuji IWAKI, Isehara, Kanagawa (JP); Kunihiko SUZUKI, Isehara, Kanagawa (JP); Hiroshi KADOMA, Sagamihara, Kanagawa (JP)

(21) Appl. No.: 17/926,179

(22) PCT Filed: May 17, 2021
(86) PCT No.: PCT/IB2021/054196

§ 371 Date: Nov. 18, 2022

(30) Foreign Application Priority Data
May 29, 2020 (JP) 2020-094266

(51) Int. Cl. H01M 10/0562; H01M 4/62; H01M 4/38; H01M 4/58; H01M 4/583

(52) U.S. Cl. CPC H01M 10/0562; H01M 4/625; H01M 4/386; H01M 4/582; H01M 4/583; H01M 2004/027

(57) ABSTRACT

One embodiment of the present invention provides a secondary battery that can be used in a wide temperature range and is less likely to be affected by the ambient temperature. A highly safe secondary battery is provided. Use of a positive electrode including a fluorine-containing electrolyte enables a secondary battery that can work in a wide temperature range, specifically, in the range of higher than or equal to −40° C. and lower than or equal to 85° C., preferably higher than or equal to −40° C. and lower than or equal to 150° C. An incombustible high molecular material or a nonflammable high molecular material is used for a binder. Furthermore, a solid electrolyte material may be included in the positive electrode to increase non-flammability.

### TECHNICAL FIELD

One embodiment of the present invention relates to a secondary battery and a manufacturing method thereof. Alternatively, one embodiment of the present invention relates to a vehicle or the like including a secondary battery.

One embodiment of the present invention relates to an object, a method, or a manufacturing method. The present invention relates to a process, a machine, manufacture, or a composition of matter. One embodiment of the present invention relates to a semiconductor device, a display device, a light-emitting device, a power storage device, a lighting device, an electronic device, or a manufacturing method thereof.

Note that electronic devices in this specification mean all devices including power storage devices, and electro-optical devices including power storage devices, information terminal devices including power storage devices, and the like are all electronic devices.

Note that in this specification, a power storage device refers to every element and device having a function of storing power. For example, a power storage device (also referred to as a secondary battery) such as a lithium-ion secondary battery, a lithium-ion capacitor, and an electric double layer capacitor are included.

### BACKGROUND ART

In recent years, a variety of power storage devices such as lithium-ion secondary batteries, lithium-ion capacitors, and air batteries, which utilize an electrochemical reaction, have been actively developed. In particular, demand for lithium-ion secondary batteries with high output and high energy density has rapidly grown with the development of the semiconductor industry, for portable information terminals such as mobile phones, smartphones, and laptop personal computers, portable music players, digital cameras, medical equipment, next-generation clean energy vehicles such as hybrid vehicles (HVs), electric vehicles (EVs), and plug-in hybrid vehicles (PHVs), and the like, and the lithium-ion secondary batteries are essential as rechargeable energy supply sources for today's information society.

A lithium-ion secondary battery has a problem in charging and discharging at low temperatures or high temperatures. A secondary battery is a power storage means utilizing a chemical reaction and thus has a difficulty in exhibiting sufficient performance at low temperatures especially below freezing. Moreover, at high temperatures, the lifetime of a lithium-ion secondary battery might be shorter and abnormality might occur.

A secondary battery that can exhibit stable performance regardless of the ambient temperature in use or storage has been needed.

Patent Document 1 discloses a lithium-ion secondary battery using a fluorine-containing electrolyte solution.

### REFERENCE

### Patent Document

[Patent Document 1] U.S. Pat. No. 10,483,522

### SUMMARY OF THE INVENTION

### Problems to be Solved by the Invention

A lithium-ion secondary battery might explode, catch fire, or the like because of an increase in the internal temperature of the lithium-ion secondary battery due to an internal short circuit, overcharging, or the like.

A secondary battery used for an electric vehicle or a hybrid vehicle is expected to be highly reliable because it is assumed to be used for a long time. A secondary battery used for an electric vehicle or a hybrid vehicle needs to be capable of high-voltage charging and to have high heat resistance.

An object of one embodiment of the present invention is to provide a secondary battery with high heat resistance.

Another object of one embodiment of the present invention is to provide a secondary battery that can be used in a wide temperature range and is less likely to be affected by the ambient temperature.

Another object is to provide a highly safe secondary battery.

Another object of one embodiment of the present invention is to provide a novel substance, a novel electrolyte, a novel positive electrode, a novel negative electrode, or a manufacturing method thereof.

Note that the description of these objects does not preclude the existence of other objects. One embodiment of the present invention does not have to achieve all these objects. Other objects can be derived from the description of the specification, the drawings, and the claims.

### Means for Solving the Problems

One embodiment of the present invention is a secondary battery including a positive electrode and a negative electrode. The positive electrode includes a fluorine-containing electrolyte, a current collector, a positive electrode active material, and a binder. The fluorine-containing electrolyte or the positive electrode active material is bound or fixed using the binder.

One kind or two or more kinds of fluorinated cyclic carbonates are used as the fluorine-containing electrolyte. The fluorinated cyclic carbonate can improve nonflammability and increase the safety of the lithium-ion secondary battery. As the fluorinated cyclic carbonate, an ethylene fluoride carbonate such as monofluoroethylene carbonate (fluoroethylene carbonate, FEC or F1EC), difluoroethylene carbonate (DFEC or F2EC), trifluoroethylene carbonate (F3EC), or tetrafluoroethylene carbonate (F4EC) can be used. Note that DFEC includes an isomer such as cis-4,5 or trans-4,5. For operation at low temperatures, as the electrolyte, it is important to use one kind or two or more kinds of fluorinated cyclic carbonates to solvate a lithium ion and transport the lithium ion in the positive electrode in charging and discharging. In the secondary battery, a group (or a cluster) of approximately several to several tens of lithium ions moves. When the fluorinated cyclic carbonate is not used as a small amount of additive but is contributed to transportation of a lithium ion in charging and discharging, operation can be performed at low temperatures.

The use of the fluorinated cyclic carbonate for the electrolyte can reduce desolvation energy that is necessary for a solvated lithium ion to enter a positive electrode active material particle in the positive electrode. The reduction in the desolvation energy can facilitate insertion or extraction of a lithium ion into/from the positive electrode active material particle even in a low-temperature range.

Monofluoroethylene carbonate (FEC) is represented by Formula (1) below.

### [Chemical Formula 1]

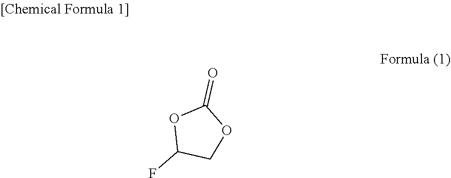

Tetrafluoroethylene carbonate (F4EC) is represented by Formula (2) below.

### [Chemical Formula 2]

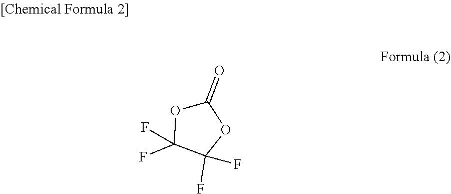

Difluoroethylene carbonate (DFEC) is represented by Formula (3) below.

### [Chemical Formula 3]

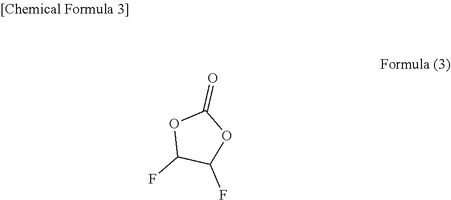

In this specification, an electrolyte is a general term of a solid material, a liquid material, a semi-solid-state material, and the like.

Deterioration is likely to occur at an interface existing in a secondary battery, e.g., an interface between a positive electrode active material and an electrolyte. The secondary battery of one embodiment of the present invention includes the fluorine-containing electrolyte in the positive electrode, which can prevent deterioration that might occur at an interface between the positive electrode active material and the electrolyte, typically, alteration of the electrolyte or a higher viscosity of the electrolyte. Alternatively, a structure may be employed in which a binder, graphene, or the like clings to or is held by the fluorine-containing electrolyte. This structure can maintain the state where the viscosity of the electrolyte in the positive electrode is low, i.e., the state where the electrolyte is smooth, and can improve the reliability of the secondary battery. Note that DFEC to which two fluorine atoms are bonded and F4EC to which four fluorine atoms are bonded have lower viscosities, are smoother, and are coordinated to lithium more weakly as compared with FEC to which one fluorine atom is bonded. Accordingly, it is possible to reduce attachment of a decomposition product with a high viscosity to a positive electrode active material particle. When a decomposition product with a high viscosity is attached to or clings to a positive electrode active material particle, a lithium ion is less likely to move at an interface between positive electrode active material particles. The solvating fluorine-containing electrolyte reduces generation of a decomposition product that is to be attached to the surface of the active material (the positive electrode active material or the negative electrode active material). Moreover, the use of the fluorine-containing electrolyte prevents attachment of a decomposition product, which prevents generation and growth of a dendrite.

The use of the fluorine-containing electrolyte as a main component is also a feature, and the amount of the fluorine-containing electrolyte is higher than or equal to 5 volume % or higher than or equal to 10 volume %, preferably higher than or equal to 30 volume % and lower than or equal to 100 volume %.

In this specification, a main component of an electrolyte occupies higher than or equal to 5 volume % of the whole electrolyte of a secondary battery. Here, “higher than or equal to 5 volume % of the whole electrolyte of a secondary battery” refers to the proportion in the whole electrolyte that is measured during manufacture of the secondary battery. In the case where a secondary battery is disassembled after manufactured, the proportions of a plurality of kinds of electrolytes are difficult to quantify, but it is possible to judge whether one kind of organic compound occupies higher than or equal to 5 volume % of the whole electrolyte.

With use of the positive electrode including the fluorine-containing electrolyte, it is possible to provide a secondary battery that can operate in a wide temperature range, specifically, higher than or equal to −40° C. and lower than or equal to 85° C., preferably higher than or equal to −40° C. and lower than or equal to 150° C.

For the binder, an incombustible high molecular material or a nonflammable high molecular material is used. For example, a fluorine polymer which is a high molecular material containing fluorine, specifically, polyvinylidene fluoride (PVDF) can be used. PVDF is a resin having a melting point in the range of higher than or equal to 134° C. and lower than or equal to 169° C., and is a material with excellent thermal stability. As another binder, a polyamide resin, a polycarbonate resin, a polyvinyl chloride resin, a polyphenylene oxide resin, or the like can be used.

In this specification, “nonflammability” refers to a property of not catching fire at all even when a high molecular material is ignited in the combustion test standard such as the UL94 standard or with an oxygen index (OI) of JIS. In addition, “incombustibility” refers to a property of hardly causing a chemical reaction even when a high molecular material is ignited in the combustion test standard such as the UL94 standard or with an oxygen index (OI) of JIS.

Alternatively, in each of the above structures, a solid electrolyte material may be further contained in the positive electrode to increase incombustibility.

In each of the above structures, as the solid electrolyte material, an oxide-based solid electrolyte can be used.

Examples of the oxide-based solid electrolyte are lithium composite oxides and lithium oxide materials such as LiPON (lithium phosphorus oxynitride), Li₂O, Li₂CO₃, Li₂MoO₄, Li₃PO₄, Li₃VO₄, Li₄SiO₄, LLT(La_{2/3-x}Li₃ₓTiO₃), and LLZ(Li₇La₃Zr₂O₁₂).

LLZ is a garnet oxide containing Li, La, and Zr and may be a compound containing Al, Ga, or Ta.

Alternatively, a polymer-based solid electrolyte such as PEO (polyethylene oxide) formed by a coating method or the like may be used. Such a polymer-based solid electrolyte can also function as a binder; thus, in the case of using a polymer-based solid electrolyte, the number of components of the positive electrode can be reduced and the manufacturing cost can also be reduced.

In the above structure, the positive electrode preferably further contains graphene. It is preferable that graphene cling to the surface of the positive electrode active material particle to fix the positive electrode active material particle and thus the conductivity be increased. Furthermore, fluorine is preferably contained in part of the graphene.

Note that graphene in this specification has a carbon hexagonal lattice structure and includes single-layer graphene or multilayer graphene including two to one hundred layers. Single-layer graphene (one graphene) refers to a one-atom-thick sheet of carbon molecules having sp² bonds. A plurality of graphene refers to multilayer graphene or a plurality of single-layer graphene. Graphene is not limited to being formed of only carbon, may be partly bonded to oxygen, hydrogen, or a functional group, and can also be referred to as a graphene compound. A graphene compound has excellent electrical characteristics of high conductivity and excellent physical properties of high flexibility and high mechanical strength in some cases. A graphene compound has a planar shape. A graphene compound enables low-resistance surface contact. Furthermore, a graphene compound has extremely high conductivity even with a small thickness in some cases and thus allows a conductive path to be formed in an active material layer efficiently even with a small amount.

A graphene compound can also function as a binder for bonding the active materials. Accordingly, the amount of the binder can be reduced, or the binder does not have to be used. This can increase the proportion of the active material in the electrode volume or the electrode weight. That is, the capacity of the secondary battery can be increased.

In the above structure, an oxide containing lithium and cobalt is preferably used as the positive electrode active material particle. The positive electrode active material particle further preferably has a crystal structure expressed by a space group R-3m, for example. The positive electrode active material preferably has an O3′ type crystal structure that is described later, particularly when the charge depth is large.

In addition, the concentration of halogen such as fluorine in a surface portion of the positive electrode active material is preferably higher than the average concentration in one entire particle.

In this manner, the surface portion of the positive electrode active material preferably has a higher concentration of fluorine than the inner portion and a composition different from that in the inner portion. In addition, the composition preferably has a crystal structure stable at normal temperature. Thus, the surface portion may have a crystal structure different from that of the inner portion. For example, at least part of the surface portion of the positive electrode active material may have a rock-salt crystal structure. Furthermore, in the case where the surface portion and the inner portion have different crystal structures, the orientations of crystals in the surface portion and the inner portion are preferably substantially aligned.

The surface portion of the positive electrode active material should contain at least an element M, and further contain an element A in the discharged state to have a path through which the element A is inserted and extracted. Note that the element A is a metal serving as a carrier ion. As the element A, an alkali metal such as lithium, sodium, or potassium or a Group 2 element such as calcium, beryllium, or magnesium can be used, for example. In the case where sodium is selected, carrier ions are sodium ions.

The element M is a transition metal, for example. As the transition metal, at least one of cobalt, manganese, and nickel can be used, for example. The active material particle used for the positive electrode of one embodiment of the present invention preferably contains one or more of cobalt, nickel, and manganese, particularly cobalt, as the element M, for example. The active material particle may contain, at an element M position, an element that has no valence number change and can have the same valence number as the element M, such as aluminum, specifically, a trivalent representative element, for example.

The negative electrode includes a current collector and a negative electrode active material particle. As the negative electrode active material, an element that enables charge and discharge reactions by alloying and dealloying reactions with lithium can be used. For example, a material containing at least one of silicon, tin, gallium, aluminum, germanium, lead, antimony, bismuth, silver, zinc, cadmium, indium, and the like can be used. Such elements have higher capacity than carbon. In particular, silicon has a high theoretical capacity of 4200 mAh/g. For this reason, silicon is preferably used as the negative electrode active material. A material in which silicon is terminated with a halogen (e.g., fluorine) is further preferably used. Alternatively, a compound containing any of the above elements may be used. For example, SiO, Mg₂Si, Mg₂Ge, SnO, SnO₂, Mg₂Sn, SnS₂, V₂Sn₃, FeSn₂, CoSn₂, Ni₃Sn₂, Cu₆Sn₅, Ag₃Sn, Ag₃Sb, Ni₂MnSb, CeSb₃, LaSn₃, La₃Co₂Sn₇, CoSb₃, InSb, and SbSn are given. Here, an element that enables charge and discharge reactions by alloying and dealloying reactions with lithium, a compound containing the element, and the like may be referred to as an alloy-based material.

In this specification and the like, SiO refers to silicon monoxide, for example. Note that SiO can alternatively be expressed as SiOₓ. Here, it is preferred that x be 1 or have an approximate value of 1. For example, x is preferably more than or equal to 0.2 and less than or equal to 1.5, and preferably more than or equal to 0.3 and less than or equal to 1.2.

As a carbon-based material, graphite, graphitizing carbon (soft carbon), non-graphitizing carbon (hard carbon), carbon nanotube, graphene, carbon black, or the like can be used. Such a carbon-based material preferably contains fluorine. A carbon-based material containing fluorine can also be referred to as a particulate or fibrous fluorocarbon material. In the case where the carbon-based material is subjected to measurement by X-ray photoelectron spectroscopy, the concentration of fluorine is preferably higher than or equal to 1 atomic % with respect to the total concentration of fluorine, oxygen, lithium, and carbon.

A material obtained by terminating an end portion of graphene with fluorine may be used. Multilayer graphene having a hole through which a lithium ion can pass may be used.

It is preferable that graphene be in contact with the surface of the negative electrode active material to fix the negative electrode active material and thus the conductivity be increased.

An electrolyte used for the secondary battery is not limited to an electrolyte containing fluorine. As long as the purpose is providing a secondary battery that can be used in a wide temperature range and is less likely to be affected by the ambient temperature, for example, a fluorine-containing electrolyte in the positive electrode and an electrolyte between the positive electrode and the negative electrode can be different from each other, and an electrolyte not containing fluorine can be used as the electrolyte between the positive electrode and the negative electrode. It can be said that one embodiment of the present invention has a structure using a fluorine-containing electrolyte at least in the positive electrode and the other structures are not particularly limited.

### Effect of the Invention

With one embodiment of the present invention, a secondary battery can be used in a wide temperature range, specifically, higher than or equal to −40° C. and lower than or equal to 150° C. Thus, even when the temperature outside a vehicle equipped with a secondary battery of one embodiment of the present invention is higher than or equal to −40° C. and lower than 25° C. or higher than or equal to 25° C. and lower than or equal to 85° C., the vehicle can be driven with the use of the secondary battery as a power source.

Moreover, when an incombustible or nonflammable material is used for a secondary battery, a secondary battery with high heat resistance can be achieved, and a nonflammable secondary battery can also be achieved. A tremendously highly safe secondary battery can also be provided.

Note that the description of these effects does not preclude the existence of other effects. One embodiment of the present invention does not have to have all of these effects. Other effects will be apparent from the descriptions of the specification, the drawings, the claims, and the like, and other effects can be derived from the descriptions of the specification, the drawings, the claims, and the like.

### BRIEF DESCRIPTION OF THE DRAWINGS

FIG. 1 is a cross-sectional schematic view illustrating the state of a positive electrode portion of a secondary battery.

FIG. 2A shows a comparative example, and FIG. 2B and FIG. 2C show chemical formulae representing embodiments of the present invention and calculated charges of oxygen atoms coordinated to lithium ions.

FIG. 3 is a graph showing solvation energy calculated in the state where one to four organic compounds are coordinated to a lithium ion representing one embodiment of the present invention.

FIG. 4 is a graph showing analysis of a charge of an oxygen atom coordinated to a lithium ion representing one embodiment of the present invention and solvation energy.

FIG. 5A and FIG. 5B are diagrams each showing a method for manufacturing a material.

FIG. 6 is an example of a cross-sectional view of a step of one embodiment of the present invention.

FIG. 7 is a diagram showing crystal structures of a positive electrode active material.

FIG. 8 is a diagram showing crystal structures of a positive electrode active material.

FIG. 9A, FIG. 9B, FIG. 9C and FIG. 9D are cross-sectional views each illustrating an example of a positive electrode of a secondary battery.

FIG. 10 is a cross-sectional schematic view of multilayer graphene and an active material.

FIG. 11A is a cross-sectional view of a semi-solid-state battery, FIG. 11B is a cross-sectional view of a positive electrode, and FIG. 11C is a cross-sectional view of an electrolyte layer.

FIG. 12A is an exploded perspective view of a coin-type secondary battery, FIG. 12B is a perspective view of the coin-type secondary battery, and FIG. 12C is a cross-sectional perspective view thereof.

FIG. 13A and FIG. 13B are examples of a cylindrical secondary battery, FIG. 13C is an example of a plurality of cylindrical secondary batteries, and FIG. 13D is an example of a power storage system including a plurality of cylindrical secondary batteries.

FIG. 14A and FIG. 14B are diagrams illustrating examples of a secondary battery, and FIG. 14C is a diagram illustrating the internal state of a secondary battery.

FIG. 15A, FIG. 15B, and FIG. 15C are diagrams illustrating an example of a secondary battery.

FIG. 16A and FIG. 16B are diagrams illustrating external views of secondary batteries.

FIG. 17A, FIG. 17B, and FIG. 17C are diagrams illustrating a method for manufacturing a secondary battery.

FIG. 18A is a perspective view illustrating a battery pack of one embodiment of the present invention, FIG. 18B is a block diagram of the battery pack, and FIG. 18C is a block diagram of a vehicle having a motor.

FIG. 19A to FIG. 19D are diagrams illustrating examples of transport vehicles.

FIG. 20A and FIG. 20B are diagrams illustrating a power storage device of one embodiment of the present invention.

FIG. 21A to FIG. 21D are diagrams illustrating examples of electronic devices.

FIG. 22A shows cycle test results with the vertical axis representing discharge capacity, and FIG. 22B shows cycle test results with the vertical axis representing capacity maintenance rate.

### MODE FOR CARRYING OUT THE INVENTION

Embodiments of the present invention will be described in detail below with reference to the drawings. Note that the present invention is not limited to the following description, and it is readily understood by those skilled in the art that modes and details of the present invention can be modified in various ways. In addition, the present invention should not be construed as being limited to the description of the following embodiments.

### Embodiment 1

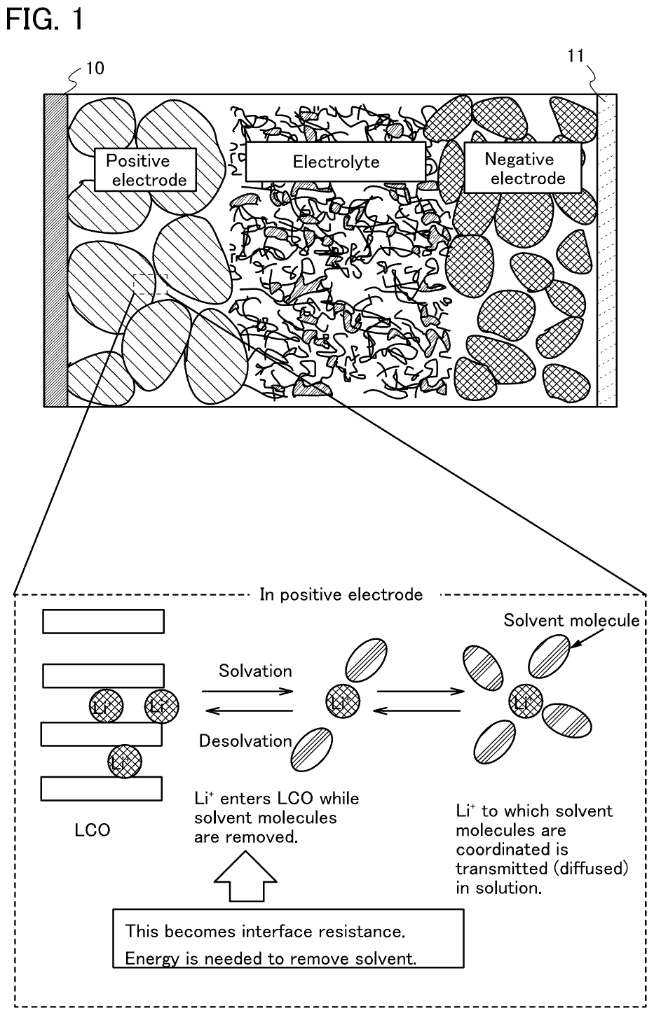

FIG. 1 is a cross-sectional schematic view illustrating the state of the inside of a secondary battery, and is also an enlarged schematic view of the state in which lithium ions in a positive electrode are solvated. Note that FIG. 1 illustrates the case where a polymer-based solid electrolyte (e.g., PEO) is used between the positive electrode and a negative electrode, and a separator for preventing a short circuit between the positive electrode and the negative electrode is not illustrated. The positive electrode includes at least a positive electrode current collector 10 and a positive electrode active material layer formed in contact with the positive electrode current collector 10, and the negative electrode includes at least a negative electrode current collector 11 and a negative electrode active material layer formed in contact with the negative electrode current collector 11.

FIG. 1 illustrates the state in which four solvent molecules are coordinated to one solvated lithium ion and the state in which two solvent molecules are coordinated to one lithium ion in the positive electrode. In addition, FIG. 1 is an enlarged view of the state of a positive electrode active material particle (LCO) and its vicinity in charging and discharging of the secondary battery, and illustrates the movement of lithium ions that moves (or are diffused) from the positive electrode active material particle. Specifically, lithium ions are released from the positive electrode active material in charging. Lithium ions move into the positive electrode active material in discharging.

The lithium ion released from the positive electrode active material in charging is brought into a state of being bonded to part of the electrolyte in the positive electrode. Note that the bond is a weak bond (coordination) by electrostatic force or the like. The state where the bond is generated by the coordination is referred to as a solvate in some cases. When an organic compound that can solvate a lithium ion contains fluorine, desolvation energy that is necessary for a solvated lithium ion to enter a positive electrode active material particle becomes low.

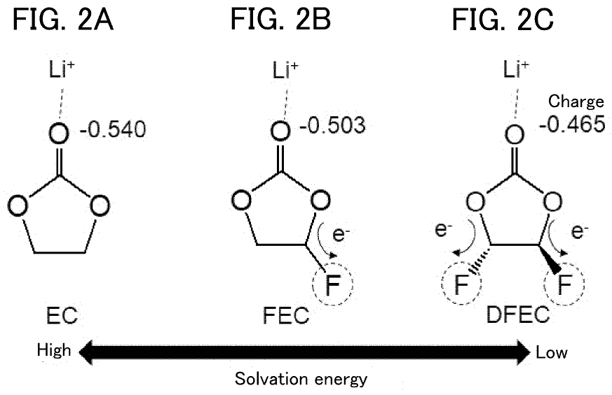

FIG. 2 illustrates lithium ions and three kinds of examples of organic compounds that can solvate the lithium ions. Note that ethylene carbonate (EC) illustrated in FIG. 2A is a comparative example, and chemical formulae of monofluoroethylene carbonate (fluoroethylene carbonate, FEC) illustrated in FIG. 2B and difluoroethylene carbonate (DFEC) illustrated in FIG. 2C and calculated charges of oxygen atoms coordinated to the lithium ions are illustrated. As illustrated in FIG. 2B and FIG. 2C, when the organic compound that can solvate the lithium ion contains fluorine, the fluorine withdraws an electron and thus the electron density of the oxygen atom coordinated to the lithium ion decreases, whereby the Coulomb force between the lithium ion and the organic compound becomes weaker than that of the comparative example (EC). For the calculation, Gaussian 09 was used as the quantum chemistry computational program. As a functional and a basis function, B3LYP and 6-311G (d,p) were used, respectively.

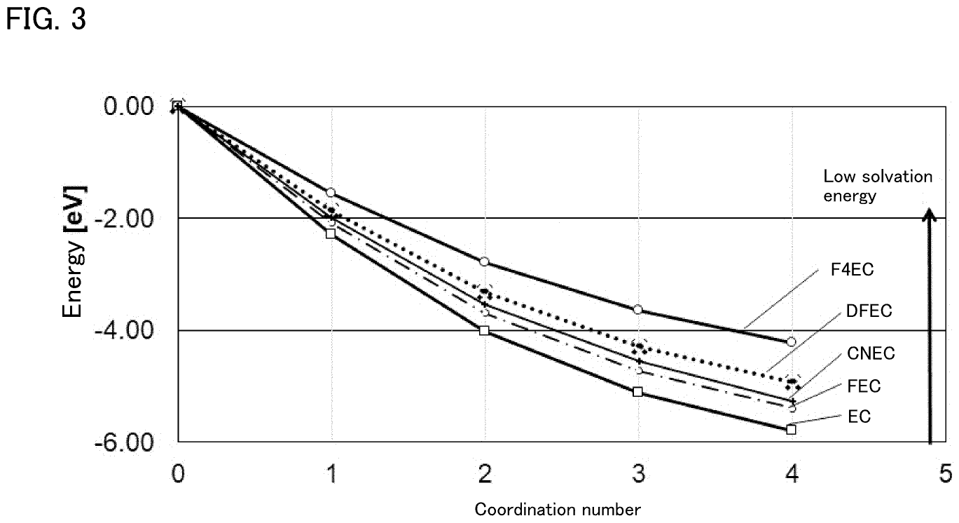

The solvation energy of tetrafluoroethylene carbonate (F4EC), which is a compound containing a larger amount of fluorine than difluoroethylene carbonate (DFEC), is calculated and shown in FIG. 3. FIG. 3 shows the results of calculation performed in the state where one to four organic compound molecules are coordinated to a lithium ion. FIG. 3 also shows the calculation result of the solvation energy of a cyclic carbonate having a cyano group (CNEC).

As shown in FIG. 3, each solvation energy is lower than that of the comparative example (EC), and tetrafluoroethylene carbonate (F4EC) has the smallest solvation energy value.

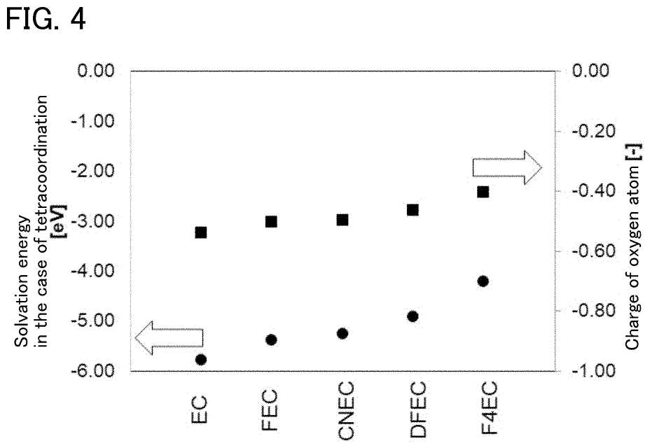

Moreover, in order to examine whether a difference in solvation energy affects the Coulomb force between the lithium ion and the electrolyte, the charge of the oxygen atom coordinated to the lithium ion was analyzed. FIG. 4 shows the analysis results.

It is found from the results in FIG. 4 that the smaller the number of negative charges of the oxygen atom coordinated to the lithium ion is, the lower the level of stabilization of energy by solvation tends to be.

Introduction of a large number of cyano groups or fluoro groups, which are electron-withdrawing groups, into a molecule can reduce the interface resistance between the electrode and the electrolyte relating to desolvation.

Accordingly, with use of an organic compound having a cyano group or a fluoro group for an electrolyte, a secondary battery can be operated even at low temperatures (higher than or equal to −40° C. and lower than 25° C.) or high temperatures (higher than or equal to 25° C. and lower than or equal to 85° C.).

### Embodiment 2

In this embodiment, a positive electrode active material in a positive electrode used for a secondary battery of one embodiment of the present invention is described.

Examples of a positive electrode active material include composite oxides having an olivine crystal structure, a layered rock-salt crystal structure, and a spinel crystal structure. Examples include compounds such as LiFePO₄, LiFeO₂, LiNiO₂, LiMn₂O₄, V₂O₅, Cr₂O₅, and MnO₂.

As a positive electrode active material, it is preferable to mix lithium nickel oxide (LiNiO₂ or LiNi₁₋ₓMₓO₂ (0<x<1) (M=Co, Al, or the like)) with a lithium-containing material that has a spinel crystal structure and contains manganese, such as LiMn₂O₄. This composition can improve the characteristics of the secondary battery.

As a positive electrode active material, a lithium-manganese composite oxide that can be represented by a composition formula LiₐMn_{b}M_{c}O_{d} can be used. Here, the element M is preferably silicon, phosphorus, or a metal element other than lithium and manganese, and further preferably nickel. When all the particles of a lithium-manganese composite oxide are measured, it is preferable to satisfy 0<a/(b+c)<2; c>0; and 0.26 (b+c)/d<0.5 at the time of discharging. Note that the proportions of metals, silicon, phosphorus, and the like in all the particles of a lithium-manganese composite oxide can be measured with, for example, an ICP-MS (inductively coupled plasma-mass spectrometer). The proportion of oxygen in all the particles of a lithium-manganese composite oxide can be measured by, for example, EDX (energy dispersive X-ray spectroscopy). Moreover, the proportion of oxygen can be measured using fusion gas analysis and valence evaluation with XAFS (X-ray absorption fine structure) spectroscopy in combination with ICPMS analysis. Note that a lithium-manganese composite oxide is an oxide containing at least lithium and manganese, and may contain at least one element selected from a group consisting of chromium, cobalt, aluminum, nickel, iron, magnesium, molybdenum, zinc, indium, gallium, copper, titanium, niobium, silicon, phosphorus, and the like.

### <Example of Manufacturing Method of Cobalt-Containing Material>

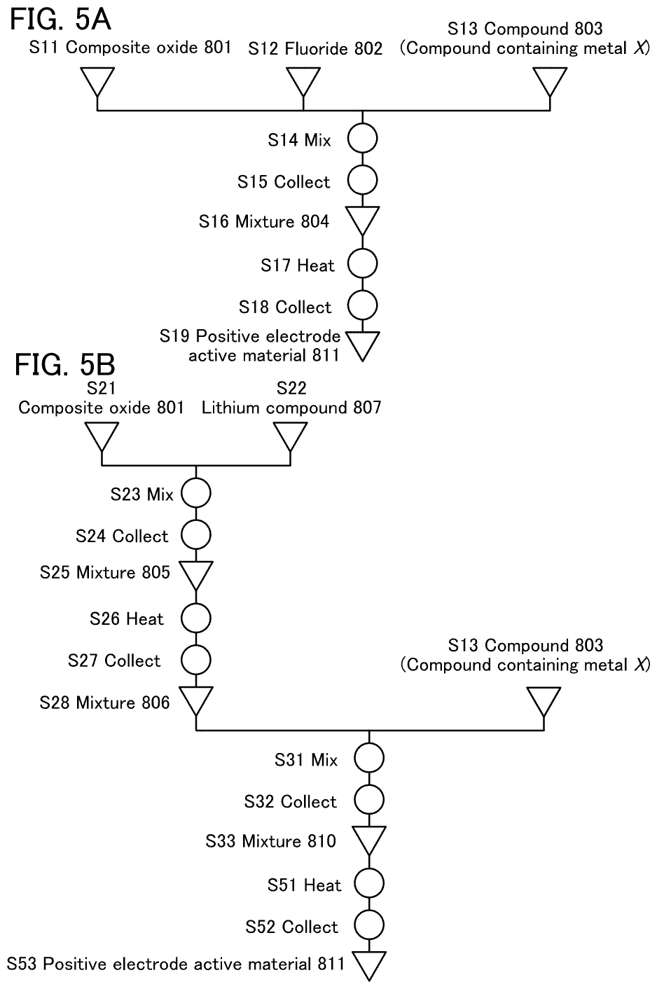

Next, an example of a manufacturing method of LiMO₂ of one embodiment of a material that can be used as the positive electrode active material is described with reference to FIG. 5A. The metal M may contain one or more kinds of metals (here, represented by the metal M) selected from cobalt, nickel, manganese, aluminum, iron, vanadium, chromium, and niobium. The metal M can contain a metal X in addition to any of the metals given as the metal M above. The metal X is a metal other than cobalt, and for example, one or a plurality of kinds of metals such as magnesium, calcium, zirconium, lanthanum, barium, copper, potassium, sodium, and zinc can be used as the metal X (or a metal X2). In particular, magnesium is preferably used as the metal X A substitution position of the metal M is not particularly limited. A cobalt-containing material in which the metal X is Mg is described as an example below. Note that the positive electrode active material of one embodiment of the present invention has a crystal structure of a lithium composite oxide represented by LiMO₂, but the composition is not limited to Li:M:O=1:1:2.

First, in Step S11, a composite oxide containing lithium, a transition metal, and oxygen is used as a composite oxide 801 containing the metal M. Here, one or more transition metals including cobalt are preferably used as the metal M.

The composite oxide containing lithium, a transition metal, and oxygen can be synthesized by heating a lithium source and a transition metal source in an oxygen atmosphere. As the transition metal source, a metal that can form, together with lithium, a layered rock-salt composite oxide belonging to the space group R-3m is preferably used. For example, at least one of manganese, cobalt, and nickel can be used. Aluminum may be used in addition to these transition metals. That is, as the transition metal source, only a cobalt source may be used; only a nickel source may be used; two types of cobalt and manganese sources or two types of cobalt and nickel sources may be used; or three types of cobalt, manganese, and nickel sources may be used. Furthermore, an aluminum source may be used in addition to these metal sources. The heating temperature at this time is preferably higher than a temperature in Step S17 described later. For example, the heating can be performed at 1000° C. This heating step is referred to as baking in some cases.

In the case where a composite oxide containing lithium, a transition metal, and oxygen that is synthesized in advance is used, a composite oxide with few impurities is preferably used. In this specification and the like, lithium, cobalt, nickel, manganese, aluminum, and oxygen are the main components of the composite oxide containing lithium, a transition metal, and oxygen, the cobalt-containing material, and the positive electrode active material, and elements other than the main components are regarded as impurities. For example, when analyzed with a glow discharge mass spectroscopy method, the total impurity concentration is preferably less than or equal to 10,000 ppmw (parts per million weight), further preferably less than or equal to 5000 ppmw. In particular, the total impurity concentration of transition metals such as titanium and arsenic is preferably less than or equal to 3000 ppmw, further preferably less than or equal to 1500 ppmw.

For example, as lithium cobalt oxide synthesized in advance, lithium cobalt oxide particles (product name: CELLSEED C-10N) formed by NIPPON CHEMICAL INDUSTRIAL CO., LTD. can be used. This is lithium cobalt oxide in which the average particle diameter (D50) is approximately 12 μm, and in the impurity analysis by a glow discharge mass spectroscopy method (GD-MS), the magnesium concentration and the fluorine concentration are less than or equal to 50 ppmw, the calcium concentration, the aluminum concentration, and the silicon concentration are less than or equal to 100 ppmw, the nickel concentration is less than or equal to 150 ppmw, the sulfur concentration is less than or equal to 500 ppmw, the arsenic concentration is less than or equal to 1100 ppmw, and the concentrations of elements other than lithium, cobalt, and oxygen are less than or equal to 150 ppmw.

The composite oxide 801 in Step S11 preferably has a layered rock-salt crystal structure with few defects and distortions. Therefore, the composite oxide is preferably a composite oxide with few impurities. In the case where the composite oxide containing lithium, the transition metal, and oxygen includes a large number of impurities, the crystal structure is highly likely to have a large number of defects or distortions.

Furthermore, a fluoride 802 is prepared in Step S12. As the fluoride, for example, lithium fluoride (LiF), magnesium fluoride (MgF₂), aluminum fluoride (AlF₃), titanium fluoride (TiF₄), cobalt fluoride (CoF₂ and CoF₃), nickel fluoride (NiF₂), zirconium fluoride (ZrF₄), vanadium fluoride (VF₅), manganese fluoride, iron fluoride, chromium fluoride, niobium fluoride, zinc fluoride (ZnF₂), calcium fluoride (CaF₂), sodium fluoride (NaF), potassium fluoride (KF), barium fluoride (BaF₂), cerium fluoride (CeF₂), lanthanum fluoride (LaF₃), or sodium aluminum hexafluoride (Na₃AlF₆) can be used. As the fluoride 802, any material that functions as a fluorine source can be used. Thus, in place of the fluoride 802 or as part thereof, fluorine (F₂), carbon fluoride, sulfur fluoride, oxygen fluoride (OF₂, O₂F₂, O₃F₂, O₄F₂, or O₂F), or the like may be used and mixed in an atmosphere.

In the case where the fluoride 802 is a compound containing the metal X, a compound 803 (a compound containing the metal X) to be described later can also serve as the fluoride 802.

In this embodiment, lithium fluoride (LiF) is prepared as the fluoride 802. LiF is preferable because it has a cation common with LiCoO₂. LiF, which has a relatively low melting point of 848° C., is preferable because it is easily melted in an annealing process described later.

In the case where LiF is used as the fluoride 802, the compound 803 (the compound containing the metal X) is preferably prepared in addition to the fluoride 802 in Step S13. The compound 803 is the compound containing the metal X.

In Step S13, the compound 803 is prepared. As the compound 803, a fluoride, an oxide, a hydroxide, or the like of the metal X can be used, and in particular, a fluoride is preferably used.

In the case where magnesium is used as the metal X, MgF₂ or the like can be used as the compound 803. Magnesium can be distributed in the vicinity of the surface of the cobalt-containing material at a higher concentration than that in the inner side.

In addition to the fluoride 802 and the compound 803, a material containing a metal that is neither cobalt nor the metal X may be mixed. As the material containing a metal (hereinafter, the metal X2) that is neither cobalt nor the metal X, a nickel source, a manganese source, an aluminum source, an iron source, a vanadium source, a chromium source, a niobium source, a titanium source, or the like can be mixed, for example. For example, a hydroxide, a fluoride, an oxide, or the like of each metal is preferably pulverized and mixed. The pulverization can be performed by a wet method, for example.

The sequence of Step S11, Step S12, and Step S13 may be freely determined.

Next, in Step S14, the materials prepared in Step S11, Step S12, and Step S13 are mixed and ground. Although the mixing can be performed by a dry method or a wet method, a wet method is preferable because the materials can be ground to a smaller size. When the mixing is performed by a wet method, a solvent is prepared. As the solvent, ketone such as acetone, alcohol such as ethanol or isopropanol, ether, dioxane, acetonitrile, N-methyl-2-pyrrolidone (NMP), or the like can be used. An aprotic solvent that hardly reacts with lithium is further preferably used. In this embodiment, acetone is used.

For example, a ball mill, a bead mill, or the like can be used for the mixing. When a ball mill is used, zirconia balls are preferably used as media, for example. The mixing and grinding steps are preferably performed sufficiently to pulverize a mixture 804.

The materials mixed and ground in the above manner are collected in Step S15, whereby the mixture 804 is obtained in Step S16.

For example, the D50 of the mixture 804 is preferably greater than or equal to 600 nm and less than or equal to 20 μm, further preferably greater than or equal to 1 μm and less than or equal to 10 μm.

Next, heating (also referred to as annealing) is performed in Step S17. This heating is preferably performed at a temperature higher than or equal to the temperature at which the mixture 804 melts. The annealing temperature in S17 is preferably lower than or equal to a decomposition temperature of LiCoO₂ (1130° C.).

LiF is used as the fluoride 802 and the annealing in S17 is performed with a lid put on, whereby a positive electrode active material 811 with favorable cycle performance and the like can be manufactured. It is considered that when LiF is used as the fluoride 802 and MgF₂ is used as the compound 803, the reaction with LiCoO₂ is promoted with the annealing temperature in S17 set to higher than or equal to 742° C. to generate LiMO₂ because the eutectic point of LiF and MgF₂ is around 742° C.

Furthermore, an endothermic peak of LiF, MgF₂, and LiCoO₂ is observed at around 820° C. by differential scanning calorimetry (DSC measurement). Thus, the annealing temperature is preferably higher than or equal to 742° C., further preferably higher than or equal to 820° C.

Accordingly, the annealing temperature is preferably higher than or equal to 742° C. and lower than or equal to 1130° C., further preferably higher than or equal to 742° C. and lower than or equal to 1000° C. Moreover, the annealing temperature is preferably higher than or equal to 820° C. and lower than or equal to 1130° C., further preferably higher than or equal to 820° C. and lower than or equal to 1000° C.

In this embodiment, LiF, which is a fluoride, is considered to function as flux. Accordingly, since the capacity of the heating furnace is larger than the capacity of the container and LiF is lighter than oxygen, it is expected that LiF is volatilized and the reduction of LiF in the mixture 804 inhibits generation of LiMO₂. Therefore, heating needs to be performed while volatilization of LiF is inhibited.

Thus, when the mixture 804 is heated in an atmosphere including LiF, that is, the mixture 804 is heated in a state where the partial pressure of LiF in the heating furnace is high, volatilization of LiF in the mixture 804 is inhibited. By performing annealing using the fluoride (LiF or MgF₂) to form an eutectic mixture with the lid put on, the annealing temperature can be lowered to the decomposition temperature of LiCoO₂ (1130° C.) or lower, specifically, a temperature higher than or equal to 742° C. and lower than or equal to 1000° C., thereby enabling the generation of LiMO₂ to progress efficiently. Accordingly, a cobalt-containing material having favorable characteristics can be formed, and the annealing time can be reduced.

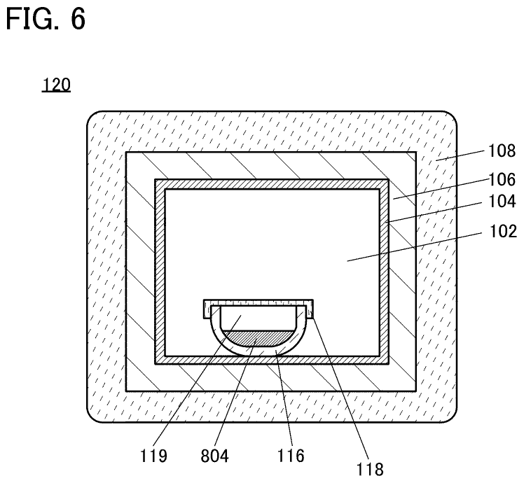

FIG. 6 illustrates an example of the annealing method in S17.

A heating furnace 120 illustrated in FIG. 6 includes a space 102 in the heating furnace, a hot plate 104, a heater unit 106, and a heat insulator 108. It is further preferable to put a lid 118 on a container 116 in annealing. With this structure, an atmosphere including a fluoride can be obtained in a space 119 enclosed by the container 116 and the lid 118. In the annealing, the state of the space 119 is maintained with the lid put on so that the concentration of the gasified fluoride inside the space 119 can be constant or cannot be reduced, in which case fluorine or magnesium can be contained in the vicinity of the particle surface. The atmosphere including a fluoride can be provided in the space 119, which is smaller in capacity than the space 102 in the heating furnace, by volatilization of a smaller amount of a fluoride. This means that an atmosphere including a fluoride can be provided in the reaction system without a significant reduction in the amount of a fluoride included in the mixture 804. Accordingly, LiMO₂ can be produced efficiently. In addition, the use of the lid 118 allows the annealing of the mixture 804 in an atmosphere including a fluoride to be simply and inexpensively performed.

Here, the valence number of Co (cobalt) in LiMO₂ formed according to one embodiment of the present invention is preferably approximately 3. The valence number of cobalt can be 2 or 3. Thus, to inhibit reduction of cobalt, it is preferable that the atmosphere in the space 102 in the heating furnace include oxygen, further preferable that the ratio of oxygen in the atmosphere in the space 102 in the heating furnace be higher than or equal to that in the air atmosphere, and still further preferable that the oxygen concentration in the atmosphere in the space 102 in the heating furnace be higher than or equal to that in the air atmosphere. Thus, an atmosphere including oxygen needs to be introduced into the space in the heating furnace. Note that since bivalent cobalt atoms existing near magnesium atoms are likely to be stable, not all the cobalt atoms may be trivalent.

Thus, in one embodiment of the present invention, before heating is performed, a step of providing an atmosphere including oxygen in the space 102 in the heating furnace and a step of placing the container 116 in which the mixture 804 is placed in the space 102 in the heating furnace are performed. The steps in this order enable the mixture 804 to be annealed (heated) in an atmosphere including oxygen and a fluoride. During the annealing, the space 102 in the heating furnace is preferably sealed to prevent any gas from being discharged to the outside. For example, it is preferable that no gas flows during the annealing.

Although there is no particular limitation on the method of providing an atmosphere including oxygen in the space 102 in the heating furnace, examples are a method of introducing an oxygen gas or a gas containing oxygen such as dry air after exhausting air from the space 102 in the heating furnace and a method of flowing an oxygen gas or a gas containing oxygen such as dry air into the space 102 in the heating furnace for a certain period of time. In particular, introducing an oxygen gas after exhausting air from the space 102 in the heating furnace (oxygen displacement) is preferably performed. Note that the atmosphere of the space 102 in the heating furnace may be regarded as an atmosphere including oxygen.

When the lid 118 is put on the container 116, an atmosphere containing oxygen is provided, and then heating is performed, an appropriate amount of oxygen enters the container 116 through a gap of the lid 118 put on the container 116 and an appropriate amount of fluoride can be kept within the container 116.

Furthermore, the fluoride or the like attached to inner walls of the container 116 and the lid 118 is likely to be fluttered again by the heating and attached to the mixture 804.

The heating in Step S17 is preferably performed at an appropriate temperature for an appropriate time. The appropriate temperature and time change depending on the conditions such as the particle size and the composition of the particle of the composite oxide 801 in Step S11. In the case where the particle size is small, the annealing is preferably performed at a lower temperature or for a shorter time than annealing in the case where the particle size is large, in some cases. After the heating in S17, a step of removing the lid is performed.

For example, in the case where the average particle diameter (D50) of particles in Step S11 is approximately 12 μm, the annealing time is preferably 3 hours or longer, further preferably 10 hours or longer.

By contrast, in the case where the average particle diameter (D50) of particles in Step S11 is approximately 5 μm, the annealing time is preferably longer than or equal to 1 hour and shorter than or equal to 10 hours, further preferably approximately 2 hours, for example.

The temperature decreasing time after the annealing is, for example, preferably longer than or equal to 10 hours and shorter than or equal to 50 hours.

Then, the materials annealed in the above manner are collected in Step S18, whereby the positive electrode active material 811 is obtained in Step S19.

FIG. 5B shows an example of a procedure different from that in FIG. 5A. FIG. 5B shows an example in which the positive electrode active material 811 is obtained through two phases; a material is added to materials mixed in the first phase.

First, in Step S21, the composite oxide 801 is prepared. In Step S22, a lithium compound 807 is prepared.

Next, in Step S23, the materials prepared in Step S21 and Step S22 are mixed and ground. For example, a solid phase method, a sol-gel method, a sputtering method, a CVD method, or the like can be used as a method for mixing.

Next, in Step S24, the materials mixed and ground in the above manner are collected, whereby a mixture 805 is obtained in Step S25.

Then, in Step S26, heating is performed and the heated materials are collected (S27), whereby a mixture 806 is obtained in Step S28.

Next, in Step S13, the compound 803 (the compound containing the metal X) is prepared.

Next, in Step S31, the mixture 806 and the compound 803 are mixed and ground.

Next, in Step S32, the materials mixed and ground in the above manner are collected, whereby a mixture 810 is obtained in Step S33. Then, heating is performed in Step S51 and the heated materials are collected (S52), whereby the positive electrode active material 811 is obtained in Step S53. The heating temperature in Step S51 is lower than the heating temperature in S26.

Although the same reference numeral is used for the positive electrode active material 811 obtained through the procedure shown in FIG. 5A and the positive electrode active material 811 obtained through the procedure shown in FIG. 5B, these materials cannot be regarded as the same materials in some cases depending on the used materials, the heating conditions, and the like.

When the positive electrode active material 811 obtained in S19 is used instead of the composite oxide 801 in Step S21, the metal X2 or an oxide thereof can be attached to the outer surface of the positive electrode active material 811 obtained in S19. In the case of using the positive electrode active material 811 obtained in S19, the metal X2 is used instead of the metal X in S13 in FIG. 5B because the metal X is used in FIG. 5A. For example, as the metal X2, zirconium oxide can be attached to the positive electrode active material 811 containing cobalt and magnesium as the metal X Note that there is a case where a core-shell structure is formed by combining the procedures in FIG. 5A and FIG. 5B.

### [Structure of Positive Electrode Active Material]

A material with a layered rock-salt crystal structure, such as lithium cobalt oxide (LiCoO₂), is known to have a high discharge capacity and excel as a positive electrode active material of a secondary battery. As an example of the material with a layered rock-salt crystal structure, a composite oxide represented by LiMO₂ is given.

It is known that the Jahn-Teller effect in a transition metal compound varies in degree according to the number of electrons in the d orbital of the transition metal.

In a compound containing nickel, distortion is likely to be caused because of the Jahn-Teller effect in some cases. Accordingly, when charging with a large charge depth is performed on LiNiO₂, the crystal structure might be broken because of the distortion. The influence of the Jahn-Teller effect is suggested to be small in LiCoO₂; hence, LiCoO₂ is preferable because the tolerance at the time of charging with a large charge depth is higher in some cases.

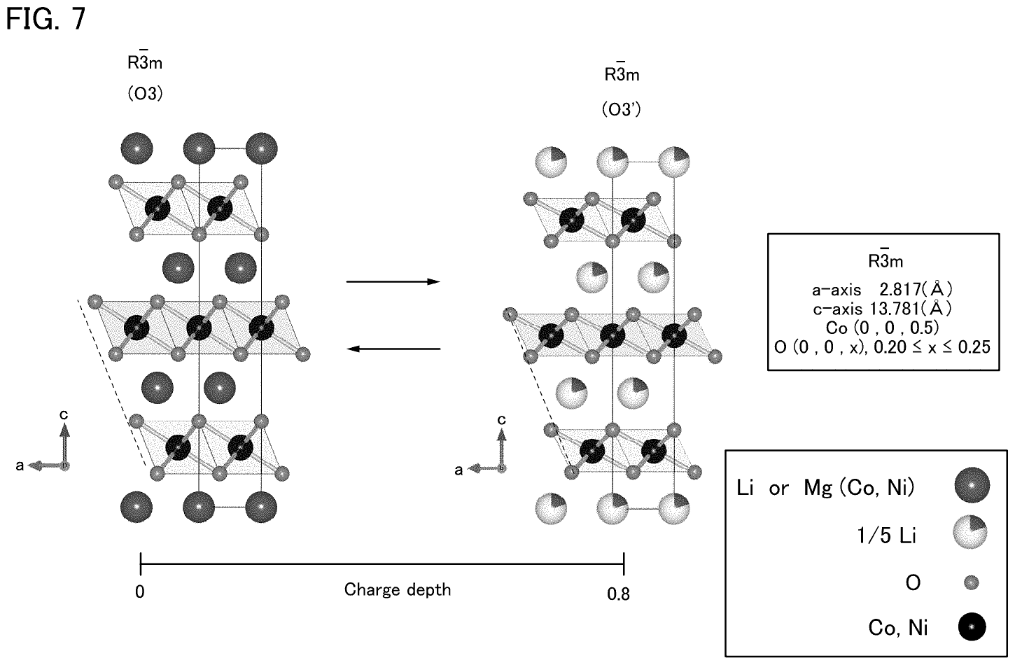

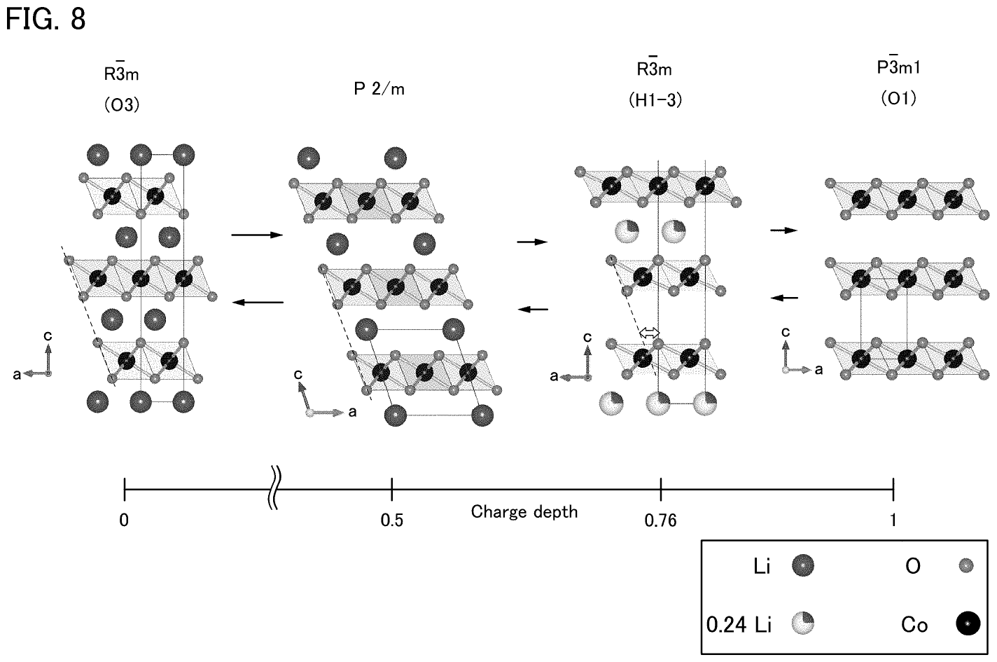

The positive electrode active material is described with reference to FIG. 7 and FIG. 8.

In the positive electrode active material formed according to one embodiment of the present invention, the difference in the positions of CoO₂ layers can be small in repeated charging and discharging with a large charge depth. Furthermore, the change in volume can be small. Thus, the compound can have excellent cycle performance. In addition, the compound can have a stable crystal structure in a state with a large charge depth. Thus, in the compound, a short circuit is less likely to occur while the state with a large charge depth is maintained, in some cases. This is preferable because the safety is further improved.

The compound has a small change in the crystal structure and a small difference in volume per the same number of transition metal atoms between a sufficiently discharged state and a sufficiently charged state.

The positive electrode active material 811 contains lithium, the metal M, and oxygen. The metal M preferably includes the metal X given above in addition to the transition metal given above. The positive electrode active material 811 preferably contains halogen such as fluorine or chlorine.

The positive electrode active material 811 preferably has a form of particles. The magnesium concentration in the surface portion is higher than the magnesium concentration in the inner portion. The surface portion of the positive electrode active material 811 is located less than or equal to 10 nm, less than or equal to 5 nm, or less than or equal to 3 nm from the surface toward the inner portion, and may include a first region where the magnesium concentration is particularly high.

For example, the concentrations of elements such as the metal M each have a gradient in each of the regions such as the surface portion, the inner portion, and the first region of the surface portion. That is, for example, the concentration of each element does not change sharply but changes with a gradient in the boundary between the regions. Here, as the metal M, aluminum, nickel, or the like can be used in addition to cobalt and magnesium, for example. In such a case, aluminum and nickel each have, for example, a concentration gradient in each of the regions such as the surface portion, the inner portion, and the first region of the surface portion.

The positive electrode active material 811 includes the first region. In the case where the positive electrode active material 811 has a form of particles, the first region preferably includes a region located inward from the surface portion. At least part of the surface portion may be included in the first region. The first region is preferably represented by a layered rock-salt crystal structure, and the region is represented by the space R-3m. The first region is a region containing lithium, the metal M, oxygen, and the metal X FIG. 7 illustrates examples of the crystal structures when the charge depth of the first region is changed. The surface portion of the positive electrode active material 811 may include a crystal that contains titanium, magnesium, and oxygen and is represented by a structure different from a layered rock-salt structure in addition to or instead of the region that is represented by a layered rock-salt structure described below with reference to FIG. 7 and the like. For example, a crystal that contains titanium, magnesium, and oxygen and is represented by a spinel structure may be included.

As illustrated in FIG. 7, in lithium cobalt oxide with a charge depth of 0 (in the discharged state), there is a region having a crystal structure of the space group R-3m, lithium occupies octahedral sites, and a unit cell includes three CoO₂ layers. The crystal structure of lithium cobalt oxide with a charge depth of 0 (in the discharged state) is R-3m (O3) as in FIG. 8. Meanwhile, the first region of the positive electrode active material 811 with a charge depth in a sufficiently charged state includes a crystal whose structure is different from the H1-3 type crystal structure. This structure belongs to the space group R-3m and is a structure in which an ion of cobalt, magnesium, or the like occupies a site coordinated to six oxygen atoms. Furthermore, the symmetry of CoO₂ layers of this structure is the same as that of the O3 type structure. Accordingly, this structure is referred to as an O3′ type crystal structure (a pseudo-spinel crystal structure) in this specification and the like. In both the O3 type crystal structure and the O3′ type crystal structure, a slight amount of magnesium preferably exists between the CoO₂ layers, i.e., in lithium sites. In addition, a slight amount of fluorine preferably exists at random in oxygen sites.

Note that in the O3′ type crystal structure, a light element such as lithium sometimes occupies a site coordinated to four oxygen atoms.

Although a chance of the existence of lithium in all lithium sites is one in five in the O3′ type crystal structure in FIG. 7, the positive electrode active material 811 of one embodiment of the present invention is not limited thereto. Lithium may exist unevenly in only some of the lithium sites. For example, lithium may exist in some lithium sites that are aligned, as in Li_{0.5}CoO₂ belonging to the space group P2/m. Distribution of lithium can be analyzed by neutron diffraction, for example.

The O3′ type crystal structure can be regarded as a crystal structure that contains Li between layers randomly and is similar to a CdCl₂ type crystal structure. The crystal structure similar to the CdCl₂ type crystal structure is close to a crystal structure of lithium nickel oxide when charged up to a charge depth of 0.94 (Li_{0.06}NiO₂); however, pure lithium cobalt oxide or a layered rock-salt positive electrode active material containing a large amount of cobalt is known not to have this crystal structure in general.

In the first region of the positive electrode active material that can be used for a secondary battery of one embodiment of the present invention, a change in the crystal structure caused when the charge depth is large and lithium is extracted is smaller than that in a conventional positive electrode active material. As shown by dotted lines in FIG. 8, for example, CoO₂ layers hardly deviate in the crystal structures.

Specifically, the first region of the positive electrode active material that can be used for a secondary battery of one embodiment of the present invention has a highly stable crystal structure even when a charge depth is large. For example, at a charge depth that makes a conventional positive electrode active material have the H1-3 type crystal structure, for example, at a voltage of approximately 4.6 V with reference to the potential of a lithium metal, there is a charge voltage region where the positive electrode active material can maintain the R-3m (O3) crystal structure. Moreover, in a higher charge voltage region, for example, at voltages of higher than or equal to 4.65 V and lower than or equal to 4.7 V with reference to the potential of a lithium metal, there is a region within which the O3′ type crystal structure can be obtained. At a much larger charge depth, a H1-3 type crystal is eventually observed in some cases. In addition, the first region of the positive electrode active material of one embodiment of the present invention might have the O3′ type crystal structure even at a lower charge voltage (e.g., a charge voltage of higher than or equal to 4.5 V and lower than 4.6 V with reference to the potential of a lithium metal).

Thus, in the first region of the positive electrode active material that can be used for a secondary battery of one embodiment of the present invention, the crystal structure is unlikely to be broken even when charging and discharging with a large charge depth are repeated.

The space group of a crystal structure is identified by XRD, electron diffraction, neutron diffraction, or the like. Thus, in this specification and the like, belonging to a space group or being a space group can be rephrased as being identified as a space group.

Note that in the case where graphite is used as a negative electrode active material in a secondary battery, for example, the voltage of the secondary battery is lower than the above-mentioned voltages by the potential of graphite. The potential of graphite is approximately 0.05 V to 0.2 V with reference to the potential of a lithium metal. Thus, even in a secondary battery which includes graphite as a negative electrode active material and which has a voltage of higher than or equal to 4.3 V and lower than or equal to 4.5 V, for example, the first region of the positive electrode active material of one embodiment of the present invention can maintain the crystal structure of R-3m (O3) and moreover, can have the O3′ type crystal structure in a larger charge depth region, e.g., at a voltage of the secondary battery of higher than 4.5 V and lower than or equal to 4.6 V. In addition, the first region of the positive electrode active material of one embodiment of the present invention can have the O3′ type crystal structure at lower charge voltages, e.g., at a voltage of the secondary battery of higher than or equal to 4.2 V and lower than 4.3 V, in some cases.

As illustrated in FIG. 7, the lattice constant of the a-axis of the O3′ type crystal structure is 2.817×10⁻¹⁰ m and the lattice constant of the c-axis is 13.781×10⁻¹⁰ m. Note that in the unit cell of the O3′ type crystal structure, the coordinates of cobalt and oxygen can be represented by Co (0, 0, 0.5) and 0 (0, 0, x) within the range of 0.20≤≤0.25.

A slight amount of an additive such as magnesium randomly existing between the CoO₂ layers, i.e., in lithium sites, can suppress a shift in the CoO₂ layers when the charge depth is large. Thus, magnesium between the CoO₂ layers makes it easier to obtain the O3′ type crystal structure.

However, heat treatment at an excessively high temperature might cause cation mixing, which increases the possibility of entry of the additive such as magnesium into the cobalt sites. Magnesium in the cobalt sites does not have the effect of maintaining the structure belonging to R-3m when the charge depth is large. Furthermore, when the heat treatment temperature is excessively high, adverse effects such as reduction of cobalt to have a valence of two and transpiration of lithium are concerned.

In view of the above, a fluorine compound is preferably added to lithium cobalt oxide before the heat treatment for distributing magnesium in the vicinity of the surface. The addition of the fluorine compound decreases the melting point of lithium cobalt oxide. The decrease in the melting point makes it easier to distribute magnesium in the vicinity of the surface at a temperature at which the cation mixing is unlikely to occur. Furthermore, the fluorine compound probably increases corrosion resistance to hydrofluoric acid generated by decomposition of an electrolyte solution.

When the magnesium concentration is higher than a desired value, the effect of stabilizing a crystal structure becomes small in some cases. This is probably because magnesium enters the cobalt sites in addition to the lithium sites. The number of magnesium atoms in the positive electrode active material of one embodiment of the present invention is preferably 0.001 to 0.1 times, further preferably larger than 0.01 times and less than 0.04 times, still further preferably approximately 0.02 times the number of cobalt atoms. Alternatively, the number of magnesium atoms preferably larger than or equal to 0.001 times and less than 0.04 times the number of cobalt atoms. Alternatively, the number of magnesium atoms preferably larger than or equal to 0.01 times and less than or equal to 0.1 times the number of cobalt atoms. The magnesium concentration described here may be a value obtained by element analysis on all the particles of the positive electrode active material using ICP-MS or the like, or may be a value based on the ratio of the raw materials mixed in the forming process of the positive electrode active material, for example.

As the metal X2 other than cobalt, one or more metals selected from nickel, aluminum, manganese, titanium, vanadium, and chromium may be added to lithium cobalt oxide, for example, and in particular, at least one of nickel and aluminum is preferably added. In some cases, manganese, titanium, vanadium, and chromium are likely to have a valence of four stably and thus contribute highly to a stable structure. The addition of the metal X2 may enable the positive electrode active material of one embodiment of the present invention to have a more stable crystal structure with a large charge depth, for example. Here, in the positive electrode active material of one embodiment of the present invention, the metal X2 is preferably added at a concentration at which the crystallinity of lithium cobalt oxide is not greatly changed. For example, the metal X2 is preferably added at an amount with which the aforementioned Jahn-Teller effect is not exhibited.

As shown in the legend in FIG. 7, aluminum and the transition metal M typified by nickel preferably exist in cobalt sites, but part of them may exist in lithium sites. Magnesium preferably exists in lithium sites. Fluorine may be substituted for part of oxygen.

As the magnesium concentration in the first region of the positive electrode active material of one embodiment of the present invention increases, the charge and discharge capacity of the positive electrode active material decreases in some cases. As an example, one reason is that the amount of lithium that contributes to charging and discharging decreases when magnesium enters the lithium sites. Another possible reason is that excess magnesium generates a magnesium compound that does not contribute to charging and discharging. When the first region of the positive electrode active material of one embodiment of the present invention contains nickel as the metal X2 in addition to magnesium, the charge and discharge capacity per weight and per volume can be increased in some cases. When the first region of the positive electrode active material of one embodiment of the present invention contains aluminum as the metal X2 in addition to magnesium, the charge and discharge capacity per weight and per volume can be increased in some cases. When the first region of the positive electrode active material of one embodiment of the present invention contains nickel and aluminum in addition to magnesium, the charge and discharge capacity per weight and per volume can be increased in some cases.

The concentrations of the elements contained in the first region of the positive electrode active material of one embodiment of the present invention, such as magnesium and the metal X2, are described below using the number of atoms.

The number of nickel atoms in the first region of the positive electrode active material of one embodiment of the present invention is preferably greater than 0% and less than or equal to 7.5%, further preferably greater than or equal to 0.05% and less than or equal to 4%, still further preferably greater than or equal to 0.1% and less than or equal to 2%, yet still further preferably greater than or equal to 0.2% and less than or equal to 1% of the number of cobalt atoms. Alternatively, the number of nickel atoms is preferably greater than 0% and less than or equal to 4% of the number of cobalt atoms. Alternatively, the number of nickel atoms is preferably greater than 0% and less than or equal to 2% of the number of cobalt atoms. Alternatively, the number of nickel atoms is preferably greater than or equal to 0.05% and less than or equal to 7.5% of the number of cobalt atoms. Alternatively, the number of nickel atoms is preferably greater than or equal to 0.05% and less than or equal to 2% of the number of cobalt atoms. Alternatively, the number of nickel atoms is preferably greater than or equal to 0.1% and less than or equal to 7.5% of the number of cobalt atoms. Alternatively, the number of nickel atoms is preferably greater than or equal to 0.1% and less than or equal to 4% of the number of cobalt atoms. The nickel concentration described here may be a value obtained by element analysis on all the particles of the positive electrode active material using GD-MS, ICP-MS, or the like, or may be a value based on the ratio of the raw materials mixed in the forming process of the positive electrode active material, for example.

Nickel contained at any of the above concentrations easily forms a solid solution uniformly throughout the first region of the positive electrode active material and thus particularly contributes to stabilization of the crystal structure of the inner portion. When divalent nickel exists in the inner portion, a slight amount of the added element having a valence of two and randomly existing in lithium sites, such as magnesium, might be able to exist more stably in the vicinity of the divalent nickel. Thus, even when charging and discharging with a large charge depth are performed, elution of magnesium might be inhibited. Accordingly, charge and discharge cycle performance might be improved. Such a combination of the effect of nickel in the inner portion and the effect of magnesium, aluminum, titanium, fluorine, or the like in the first region extremely effectively stabilizes the crystal structure when the charge depth is large.

The number of aluminum atoms in the first region of the positive electrode active material of one embodiment of the present invention is preferably greater than or equal to 0.05% and less than or equal to 4%, further preferably greater than or equal to 0.1% and less than or equal to 2%, still further preferably greater than or equal to 0.3% and less than or equal to 1.5% of the number of cobalt atoms. Alternatively, the number of aluminum atoms is preferably greater than or equal to 0.05% and less than or equal to 2% of the number of cobalt atoms. Alternatively, the number of aluminum atoms is preferably greater than or equal to 0.1% and less than or equal to 4% of the number of cobalt atoms. The aluminum concentration described here may be a value obtained by element analysis on all the particles of the positive electrode active material using GD-MS, ICP-MS, or the like, or may be a value based on the ratio of the raw materials mixed in the process of forming the positive electrode active material, for example.

It is preferable that the positive electrode active material of one embodiment of the present invention contain an element W and phosphorus be used as the element W. The positive electrode active material of one embodiment of the present invention further preferably contains a compound containing phosphorus and oxygen.

When the positive electrode active material of one embodiment of the present invention contains a compound containing the element W, a short circuit can be inhibited while a state with a large charge depth is maintained, in some cases.

When the positive electrode active material of one embodiment of the present invention contains phosphorus as the element X, phosphorus might react with hydrogen fluoride generated by the decomposition of the electrolyte solution, which might decrease the hydrogen fluoride concentration in the electrolyte solution.

In the case where the electrolyte solution contains LiPF₆, hydrogen fluoride may be generated by hydrolysis. In some cases, hydrogen fluoride is generated by the reaction of PVDF used as a component of the positive electrode and alkali. The decrease in the hydrogen fluoride concentration in the electrolyte solution can inhibit corrosion and coating film separation of a current collector in some cases. Furthermore, the decrease in the hydrogen fluoride concentration in the electrolyte solution can inhibit a reduction in adhesion properties due to gelling or insolubilization of PVDF in some cases.

When containing magnesium in addition to the element X, the positive electrode active material of one embodiment of the present invention is extremely stable at a large charge depth. When the element X is phosphorus, the number of phosphorus atoms is preferably greater than or equal to 1% and less than or equal to 20%, further preferably greater than or equal to 2% and less than or equal to 10%, still further preferably greater than or equal to 3% and less than or equal to 8% of the number of cobalt atoms. Alternatively, the number of phosphorus atoms is preferably greater than or equal to 1% and less than or equal to 10% of the number of cobalt atoms. Alternatively, the number of phosphorus atoms is preferably greater than or equal to 1% and less than or equal to 8% of the number of cobalt atoms. Alternatively, the number of phosphorus atoms is preferably greater than or equal to 2% and less than or equal to 20% of the number of cobalt atoms. Alternatively, the number of phosphorus atoms is preferably greater than or equal to 2% and less than or equal to 8% of the number of cobalt atoms. Alternatively, the number of phosphorus atoms is preferably greater than or equal to 3% and less than or equal to 20% of the number of cobalt atoms. Alternatively, the number of phosphorus atoms is preferably greater than or equal to 3% and less than or equal to 10% of the number of cobalt atoms. In addition, the number of magnesium atoms is preferably greater than or equal to 0.1% and less than or equal to 10%, further preferably greater than or equal to 0.5% and less than or equal to 5%, still further preferably greater than or equal to 0.7% and less than or equal to 4% of the number of cobalt atoms. Alternatively, the number of magnesium atoms is preferably greater than or equal to 0.1% and less than or equal to 5% of the number of cobalt atoms. Alternatively, the number of magnesium atoms is preferably greater than or equal to 0.1% and less than or equal to 4% of the number of cobalt atoms. Alternatively, the number of magnesium atoms is preferably greater than or equal to 0.5% and less than or equal to 10% of the number of cobalt atoms. Alternatively, the number of magnesium atoms is preferably greater than or equal to 0.5% and less than or equal to 4% of the number of cobalt atoms. Alternatively, the number of magnesium atoms is preferably greater than or equal to 0.7% and less than or equal to 10% of the number of cobalt atoms. Alternatively, the number of magnesium atoms is preferably greater than or equal to 0.7% and less than or equal to 5% of the number of cobalt atoms. The phosphorus concentration and the magnesium concentration described here may each be a value obtained by element analysis on all the particles of the positive electrode active material using ICP-MS or the like, or may be a value based on the ratio of the raw materials mixed in the process of forming the positive electrode active material, for example.

The first region of the positive electrode active material 811 contains at least fluorine in addition to cobalt, the metal M, and oxygen. By combining the positive electrode active material 811 and the structure described in Embodiment 1 in which an electrolyte using a fluorine-containing compound is included in the positive electrode, a synergy effect of dramatically improved stability can be obtained.

### <Particle Diameter>

When the particle diameter of the positive electrode active material 811 of one embodiment of the present invention is too large, there are problems such as difficulty in lithium diffusion and too much surface roughness of an active material layer at the time when the material is applied to a current collector. By contrast, too small a particle diameter causes problems such as difficulty in supporting the active material layer at the time when the material is applied to the current collector and overreaction with the electrolyte solution. Therefore, the median diameter (D50) is preferably greater than or equal to 1 μm and less than or equal to 100 μm, further preferably greater than or equal to 2 μm and less than or equal to 40 μm, still further preferably greater than or equal to 5 μm and less than or equal to 30 μm. Alternatively, the D50 is preferably greater than or equal to 1 μm and less than or equal to 40 μm. Alternatively, the D50 is preferably greater than or equal to 1 μm and less than or equal to 30 μm. Alternatively, the D50 is preferably greater than or equal to 2 μm and less than or equal to 100 μm. Alternatively, the D50 is preferably greater than or equal to 2 μm and less than or equal to 30 μm. Alternatively, the D50 is preferably greater than or equal to 5 μm and less than or equal to 100 μm. Alternatively, the D50 is preferably greater than or equal to 5 μm and less than or equal to 40 μm.

### <Analysis Method>

Whether or not a positive electrode active material has the O3′ type crystal structure when the charge depth is large can be determined by analyzing a positive electrode including the positive electrode active material with a large charge depth using XRD, electron diffraction, neutron diffraction, electron spin resonance (ESR), nuclear magnetic resonance (NMR), or the like. The XRD is particularly preferable because the symmetry of a transition metal such as cobalt contained in the positive electrode active material can be analyzed with high resolution, the degrees of crystallinity and the crystal orientations can be compared, the distortion of lattice periodicity and the crystallite size can be analyzed, and a positive electrode obtained only by disassembling a secondary battery can be measured with sufficient accuracy, for example.

As described so far, the positive electrode active material 811 has a feature of a small change in the crystal structure between the state with a large charge depth and the discharged state. A material where 50 wt % or more of the crystal structure largely changes between the state with a large charge depth and the discharged state is not preferable because the material cannot withstand the charging and discharging with a large charge depth. In addition, it should be noted that an objective crystal structure is not obtained in some cases only by addition of impurity elements. For example, in a state with a large charge depth, lithium cobalt oxide containing magnesium and fluorine has the O3′ type structure at 60 wt % or more in some cases, and has the H1-3 type structure at 50 wt % or more in other cases. In some cases, lithium cobalt oxide containing magnesium and fluorine may have the O3′ type crystal structure at almost 100 wt % at a predetermined voltage, and increasing the voltage to be higher than the predetermined voltage may cause the H1-3 type crystal structure. Thus, the crystal structure of the positive electrode active material 811 is preferably analyzed by XRD or the like. The combination of the analysis methods and measurement such as XRD enables more detailed analysis.

Note that a positive electrode active material in the state with a large charge depth or the discharged state sometimes causes a change in the crystal structure when exposed to air. For example, the O3′ type crystal structure changes into the H1-3 type crystal structure in some cases. Thus, all samples are preferably handled in an inert atmosphere such as an atmosphere including argon.

The positive electrode active material illustrated in FIG. 8 is lithium cobalt oxide (LiCoO₂) to which the metal X is not added. The crystal structure of lithium cobalt oxide illustrated in FIG. 8 is changed depending on the charge depth.

As illustrated in FIG. 8, in lithium cobalt oxide with a charge depth of 0 (in the discharged state), there is a region having a crystal structure of the space group R-3m, lithium occupies octahedral sites, and a unit cell includes three CoO₂ layers. Thus, this crystal structure is referred to as an O3 type crystal structure in some cases. Note that the CoO₂ layer has a structure in which an octahedral structure with cobalt coordinated to six oxygen atoms continues on a plane in an edge-shared state.

Lithium cobalt oxide with a charge depth of 1 has the crystal structure of the space group P-3m1 and includes one CoO₂ layer in a unit cell. Thus, this crystal structure is referred to as an 01 type crystal structure in some cases.

Moreover, lithium cobalt oxide with a charge depth of approximately 0.8 has the crystal structure of the space group R-3m. This structure can also be regarded as a structure in which CoO₂ structures such as P-3m1 (O1) and LiCoO₂ structures such as R-3m (O3) are alternately stacked. Thus, this crystal structure is referred to as an H1-3 type crystal structure in some cases. Note that the number of cobalt atoms per unit cell in the actual H1-3 type crystal structure is twice as large as that of cobalt atoms per unit cell in other structures. However, in this specification including FIG. 8, the c-axis of the H1-3 type crystal structure is half that of the unit cell for easy comparison with the other crystal structures.

For the H1-3 type crystal structure, the coordinates of cobalt and oxygen in the unit cell can be expressed as follows, for example: Co (0, 0, 0.42150±0.00016), O₁ (0, 0, 0.27671±0.00045), and O₂ (0, 0, 0.11535±0.00045). O₁ and O₂ are each an oxygen atom. In this manner, the H1-3 type crystal structure is represented by a unit cell including one cobalt and two oxygen. A preferred unit cell for representing a crystal structure in a positive electrode active material is selected such that the value of GOF (goodness of fit) is smaller in the Rietveld analysis of XRD, for example.

When charge with a high voltage of 4.6 V or higher based on the redox potential of a lithium metal or charge with a large charge depth of 0.8 or more and discharge are repeated, the crystal structure of lithium cobalt oxide changes (i.e., an unbalanced phase change occurs) repeatedly between the H1-3 type crystal structure and the R-3m (O3) structure in the discharged state.

However, there is a large deviation in the positions of the CoO₂ layers between these two crystal structures. As indicated by dotted lines and an arrow in FIG. 8, the CoO₂ layer in the H1-3 type crystal structure largely deviates from that in the R-3m (O3). Such a dynamic structural change might adversely affect the stability of the crystal structure.

A difference in volume is also large. The H1-3 type crystal structure and the O3 type crystal structure in the discharged state that contain the same number of cobalt atoms have a difference in volume of 3.0% or more.

In addition, a structure in which CoO₂ layers are continuous, such as P-3m1 (O1), included in the H1-3 type crystal structure is highly likely to be unstable.

Thus, the repeated charging and discharging with a large charge depth gradually break the crystal structure of lithium cobalt oxide. The break of the crystal structure degrades the cycle performance. The break of the crystal structure reduces sites where lithium can stably exist and makes it difficult to insert and extract lithium.

### [Positive Electrode]

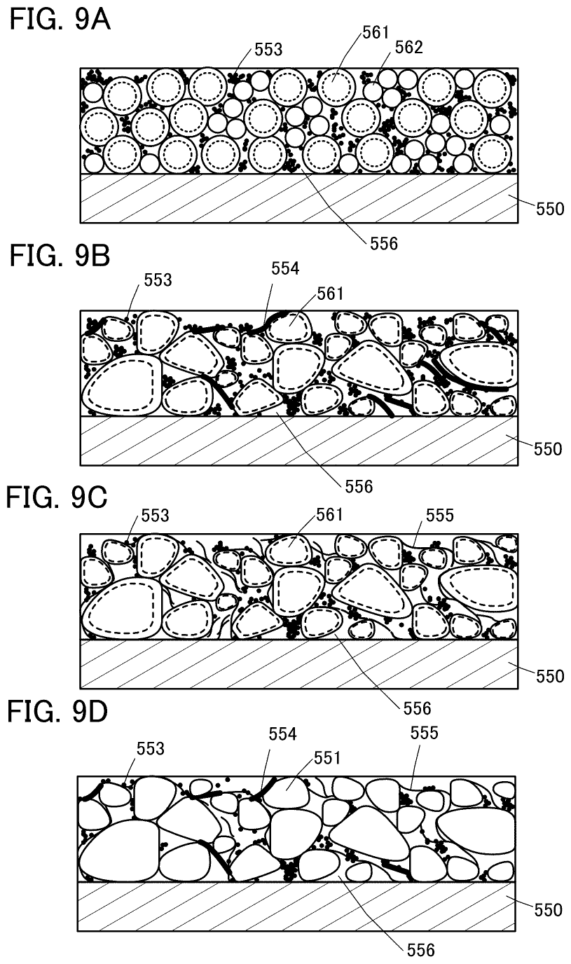

The positive electrode includes a positive electrode active material layer and a positive electrode current collector. FIG. 9A is an example of a cross-sectional schematic view of the positive electrode. FIG. 9A illustrates a cross section after a secondary battery has been manufactured. Regions 556 not filled with a plurality of active materials 561 or acetylene black 553 are filled with a fluorine-containing electrolyte, a binder, a solid electrolyte material, or the like. The region 556 in the positive electrode has low viscosity and is in the state where lithium easily moves or diffuses. Note that a space is sometimes generated in the case where an electrolyte or the like does not successfully fill a portion between the plurality of active materials 561.

A current collector 550 is metal foil, and the positive electrode is formed by applying slurry onto the metal foil and drying the slurry. Pressing may be performed after drying. The positive electrode is a component obtained by forming an active material layer over the current collector 550.

Slurry refers to a material solution that is used to form an active material layer over the current collector 550 and includes at least an active material, a binder, and a solvent, preferably also a conductive additive mixed therewith. Slurry may also be referred to as slurry for an electrode or active material slurry; in some cases, slurry for forming a positive electrode active material layer is referred to as slurry for a positive electrode, and slurry for forming a negative electrode active material layer is referred to as slurry for a negative electrode.

A conductive additive is also referred to as a conductivity-imparting agent or a conductive material, and a carbon material is used. A conductive additive is attached between a plurality of active materials, whereby the plurality of active materials are electrically connected to each other, and the conductivity increases. Note that the term “attach” refers not only to a state where an active material and a conductive additive are physically in close contact with each other, and includes, for example, the following concepts: the case where covalent bonding occurs, the case where bonding with the Van der Waals force occurs, the case where a conductive additive covers part of the surface of an active material, the case where a conductive additive is embedded in surface roughness of an active material, and the case where an active material and a conductive additive are electrically connected to each other without being in contact with each other.

Typical examples of the carbon material used as the conductive additive include carbon black (e.g., furnace black, acetylene black, and graphite).

In FIG. 9A, the acetylene black 553 is shown as the conductive additive. FIG. 9A shows an example in which second active materials 562 having a smaller particle diameter than first active material particles are mixed. The positive electrode in which particles with different particle sizes are mixed can have high density. Note that the first active material particle corresponds to the active material 561 in FIG. 9A. When the particle sizes and densities are intentionally uneven in this manner, the amount of change in the whole positive electrode in expansion and contraction can be reduced.

Note that the expression “the first active material particle has a core-shell structure (also referred to as a core-shell-type structure)” is used in some cases.

In the first active material particle, NCM is used for its core and NCM that has a composition different from the composition of NCM used for the core is used for its shell. For the first active material particle, a lithium composite oxide using cobalt, nickel, and manganese such as a NiCoMn-based material (also referred to as NCM) represented by LiNiₓCo_{y}Mn_{z}O₂ (x>0, y>0, z>0, 0.8<x+y+z<1.2) can be used, for example. Specifically, 0.1x<y<8x and 0.1x<z<8x are preferably satisfied, for example. For example, x, y, and z preferably satisfy x:y:z=1:1:1 or the neighborhood thereof. Alternatively, for example, x, y, and z preferably satisfy x:y:z=5:2:3 or the neighborhood thereof. Alternatively, for example, x, y, and z preferably satisfy x:y:z=8:1:1 or the neighborhood thereof. Alternatively, for example, x, y, and z preferably satisfy x:y:z=9:0.5:0.5 or the neighborhood thereof. Alternatively, for example, x, y, and z preferably satisfy x:y:z=6:2:2 or the neighborhood thereof. Alternatively, for example, x, y, and z preferably satisfy x:y:z=1:4:1 or the neighborhood thereof. The first active material particle may have a structure in which LCO is used for its core and NCM is used for its shell. Alternatively, LCO may be used for its core and LFP may be used for its shell. Note that LCO is an abbreviation for lithium cobalt oxide (LiCoO₂), and LFP is an abbreviation for lithium iron phosphate (LiFePO₄).

In the positive electrode of the secondary battery, a binder (a resin) is mixed in order to fix the current collector 550 such as metal foil and the active material. The binder is also referred to as a binding agent. Since the binder is a high molecular material, a large amount of the binder lowers the proportion of the active material in the positive electrode, thereby reducing the discharge capacity of the secondary battery. Therefore, the amount of the binder mixed is reduced to a minimum. In FIG. 9A, the region 556 that is not filled with the active material 561, the second active material 562, or the acetylene black 553 represents an electrolyte, a space, or a binder. The volumes of the active material 561 and the second active material 562 sometimes change in charging and discharging; however, a fluorine-containing electrolyte such as fluorinated carbonate ester between the active materials 561 or the second active materials 562 maintains smoothness and suppresses a crack even when the volumes change in charging and discharging, so that an effect of dramatically increasing the cycle performance is obtained. It is important to have an organic compound containing fluorine between a plurality of active materials included in the positive electrode.

In FIG. 9A, the boundary between the core region and the shell region of the active material 561 is indicated by a dotted line in the active material 561. Although FIG. 9A shows an example in which the active material 561 has a spherical shape, there is no particular limitation and other various shapes can be employed. The cross-sectional shape of the active material 561 may be an ellipse, a rectangle, a trapezoid, a pyramid, a quadrilateral with rounded corners, or an asymmetrical shape.

FIG. 9B shows an example in which the active materials 561 have various shapes. FIG. 9B shows the example different from that in FIG. 9A.

In the positive electrode in FIG. 9B, graphene 554 is used as a carbon material used as the conductive additive. The graphene 554 is positioned around the active material 561 so as to cling to the active material 561 like Bacillus subtilis var. natto.

Graphene has electrically, mechanically, or chemically remarkable characteristics.

In FIG. 9B, a positive electrode active material layer including the active material 561, the graphene 554, and the acetylene black 553 is formed over the current collector 550.

In the step of mixing the graphene 554 and the acetylene black 553 to obtain an electrode slurry, the weight of mixed carbon black is preferably 1.5 times to 20 times, further preferably 2 times to 9.5 times the weight of graphene.

When the graphene 554 and the acetylene black 553 are mixed in the above range, the acetylene black 553 can be dispersed uniformly and less likely to be aggregated at the time of preparing the slurry. Furthermore, when the graphene 554 and the acetylene black 553 are mixed in the above range, the electrode density can be higher than that of an electrode using only the acetylene black 553 as a conductive additive. As the electrode density is higher, the capacity per unit weight can be higher. Specifically, the density of the positive electrode active material layer measured by gravimetry can be higher than 3.5 g/cc. In addition, it is preferable that the first active material particle be used for the positive electrode and the graphene 554 and the acetylene black 553 be mixed in the above range, in which case a synergy effect for higher capacity of the secondary battery can be expected.

The electrode density is lower than that of a positive electrode containing only graphene as a conductive additive, but when a first carbon material (graphene) and a second carbon material (acetylene black) are mixed in the above range, fast charging can be achieved. It is preferable to use the positive electrode described in Embodiment 1 to increase the capacity of the secondary battery, in which case a synergy effect for dramatically increasing the stability of the secondary battery can be expected.

The above features are advantageous for secondary batteries for vehicles.

When a vehicle becomes heavier with an increasing number of secondary batteries, more energy is needed to move the vehicle, which shortens the driving range. With the use of a high-density secondary battery, the driving range of the vehicle can be maintained with almost no change in the total weight of a vehicle including a secondary battery having the same weight.

Since electric power is needed to charge the secondary battery with higher capacity in the vehicle, it is desirable to end charging fast. What is called a regenerative charging, in which electric power is temporarily generated when the vehicle is braked and the electric power is used for charging, is performed under high rate charging conditions; thus, a secondary battery for a vehicle is desired to have favorable rate characteristics.

When the first active material particle is used for the positive electrode, the mixing ratio of acetylene black to graphene is set in the optimal range, and the positive electrode described in Embodiment 1 is used, a secondary battery for a vehicle which has a wide temperature range can be obtained.

This structure is also effective in a portable information terminal, and using the first active material particle for the positive electrode and setting the mixing ratio of acetylene black to graphene in the optimal range enable a small secondary battery with high capacity. Setting the mixing ratio of acetylene black to graphene in the optimal range also enables fast charging of a portable information terminal.

In FIG. 9B, the boundary between the core region and the shell region of the active material 561 is indicated by a dotted line in the active material 561. In FIG. 9B, the region 556 that is not filled with the active material 561, the graphene 554, or the acetylene black 553 represents an electrolyte, a space, a solid electrolyte material, or a binder. A space is required for the electrolyte to penetrate the positive electrode; too many spaces lower the electrode density, too few spaces do not allow the electrolyte to penetrate the positive electrode, and a space that remains after the secondary battery is completed lowers the efficiency. The volume of the active material 561 sometimes changes in charging and discharging; however, a fluorine-containing electrolyte such as fluorinated carbonate ester between the plurality of active materials 561 in the positive electrode maintains smoothness and suppresses a crack even when the volume changes in charging and discharging, so that an effect of dramatically increasing the cycle performance is obtained. It is important to have an organic compound containing fluorine between a plurality of active materials included in a positive electrode.

Using the first active material particle for the positive electrode and setting the mixing ratio of acetylene black and graphene in the optimal range enable both higher electrode density and formation of an appropriate space needed for ion conduction, whereby a secondary battery which has high energy density and favorable output characteristics can be obtained.

FIG. 9C shows an example of a positive electrode in which a carbon nanotube 555 is used instead of graphene. FIG. 9C shows the example different from that in FIG. 9B. With the use of the carbon nanotube 555, aggregation of carbon black such as the acetylene black 553 can be prevented and the dispersibility can be increased.

In FIG. 9C, the region 556 that is not filled with the active material 561, the carbon nanotube 555, or the acetylene black 553 represents an electrolyte, a solid electrolyte material, a space, or a binder. The volume of the active material 561 sometimes changes in charging and discharging; however, a fluorine-containing electrolyte such as fluorinated carbonate ester between the plurality of active materials 561 in the positive electrode maintains smoothness and suppresses a crack even when the volume changes in charging and discharging, so that an effect of dramatically increasing the cycle performance is obtained. It is important to have an organic compound containing fluorine between a plurality of active materials included in a positive electrode.

FIG. 9D shows another example of a positive electrode. FIG. 9D shows an example in which an active material 551 does not have the core-shell structure. FIG. 9D shows an example in which the carbon nanotube 555 is used in addition to the graphene 554. With the use of both the graphene 554 and the carbon nanotube 555, aggregation of carbon black such as the acetylene black 553 can be prevented and the dispersibility can be further increased.

In FIG. 9D, the region 556 that is not filled with the active material 551, the carbon nanotube 555, the graphene 554, or the acetylene black 553 represents an electrolyte, a solid electrolyte material, a space, or a binder. The volume of the active material 551 sometimes changes in charging and discharging; however, a fluorine-containing electrolyte such as fluorinated carbonate ester between the plurality of active materials 551 in the positive electrode maintains smoothness and suppresses a crack even when the volume changes in charging and discharging, so that an effect of dramatically increasing the cycle performance is obtained. It is important to have an organic compound containing fluorine between a plurality of active materials included in a positive electrode.

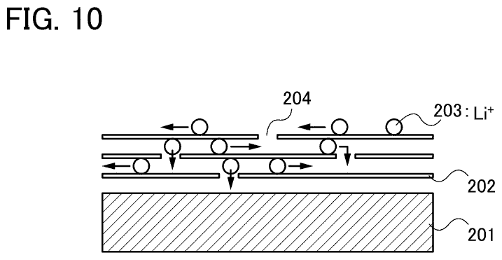

FIG. 10 is a schematic view illustrating a state of multilayer graphene including a space (also referred to as a hole in some cases) and an active material. When a lithium ion moves in a plane of graphene 202 due to charging and discharging and reaches a space 204, the lithium ion moves to a lower layer of graphene in the case where an electrode 201 (an active material in the case of a secondary battery) which is close to the graphene 202 has a negative potential (the lithium ion moves to an upper layer of graphene in the case where the electrode 201 has a positive potential). Although one lithium ion is illustrated in FIG. 10 for simplicity, the actual number of lithium is not one and a group (or a cluster) of several to several tens of lithium moves in an electrolyte. This idea has not described in conventionally known documents and conventional books (including textbooks and the like), and is a novel solvation model discovered by the present inventors. It is considered that in some fluorine-containing electrolytes to be used, the way of solvation might be different depending on the number of bonded fluoride ions.

In FIG. 10, the same phenomenon occurs not only in the case of multilayer graphene provided in the vicinity of the positive electrode active material but also in the case of multilayer graphene provided in the vicinity of the negative electrode active material. Not single lithium but an aggregate of a plurality of lithium actually moves in the negative electrode active material.

A secondary battery can be manufactured by using any one of the positive electrodes in FIG. 9A, FIG. 9B, FIG. 9C, and FIG. 9D; setting, in a container (e.g., an exterior body or a metal can) or the like, a stack in which a separator is provided over the positive electrode and a negative electrode is provided over the separator; and filling the container with an electrolyte.

Although the above structure is an example of a secondary battery using a liquid electrolyte, one embodiment of the present invention is not particularly limited thereto. For example, a semi-solid-state battery or an all-solid-state battery can also be manufactured.

In this specification and the like, a layer positioned between a positive electrode and a negative electrode is referred to as an electrolyte layer both in the case of a secondary battery using a liquid electrolyte and in the case of a semi-solid-state battery. An electrolyte layer of a semi-solid-state battery can be regarded as a layer formed by deposition, and can be distinguished from a liquid electrolyte layer.

In the case of using a liquid electrolyte layer for the secondary battery, without limitation to a fluorine-containing electrolyte, another material can also be used. For the electrolyte layer, for example, one of ethylene carbonate (EC), propylene carbonate (PC), butylene carbonate, chloroethylene carbonate, vinylene carbonate, γ-butyrolactone, γ-valerolactone, dimethyl carbonate (DMC), diethyl carbonate (DEC), ethyl methyl carbonate (EMC), methyl formate, methyl acetate, ethyl acetate, methyl propionate, ethyl propionate, propyl propionate, methyl butyrate, 1,3-dioxane, 1,4-dioxane, dimethoxyethane (DME), dimethyl sulfoxide, diethyl ether, methyl diglyme, acetonitrile, benzonitrile, tetrahydrofuran, sulfolane, and sultone can be used, or two or more of these can be used in an appropriate combination at an appropriate ratio.

Alternatively, the use of one or more ionic liquids (room temperature molten salts) that are less likely to burn and volatize as the solvent of the electrolyte can prevent a secondary battery from exploding or catching fire even when the secondary battery internally shorts out or the temperature of the internal region increases owing to overcharging or the like. An ionic liquid contains a cation and an anion, specifically, an organic cation and an anion. Examples of the organic cation include aliphatic onium cations such as a quaternary ammonium cation, a tertiary sulfonium cation, and a quaternary phosphonium cation, and aromatic cations such as an imidazolium cation and a pyridinium cation. Examples of the anion include a monovalent amide-based anion, a monovalent methide-based anion, a fluorosulfonate anion, a perfluoroalkylsulfonate anion, a tetrafluoroborate anion, a perfluoroalkylborate anion, a hexafluorophosphate anion, and a perfluoroalkylphosphate anion.

As a salt dissolved in the above-described solvent, one of lithium salts such as LiPF₆, LiClO₄, LiAsF₆, LiBF₄, LiAlCl₄, LiSCN, LiBr, LiI, Li₂SO₄, Li₂B₁₀Cl₁₀, Li₂B₁₂Cl₁₂, LiCF₃SO₃, LiC₄F₉SO₃, LiC(CF₃SO₂)₃, LiC(C₂F₅SO₂)₃, LiN(CF₃SO₂)₂, LiN(C₄F₉SO₂) (CF₃SO₂), and LiN(C₂F₅SO₂)₂ can be used, or two or more of these lithium salts can be used in an appropriate combination at an appropriate ratio.

In this specification and the like, a semi-solid-state battery refers to a battery in which at least one of an electrolyte layer, a positive electrode, and a negative electrode includes a semi-solid-state material. The term “semi-solid-state” here does not mean that the proportion of a solid-state material is 50%. The term “semi-solid-state” means having properties of a solid, such as a small volume change, and also having some of properties close to those of a liquid, such as flexibility. A single material or a plurality of materials can be used as long as the above properties are satisfied. For example, a porous solid-state material infiltrated with a liquid material may be used.

In this specification and the like, a polymer electrolyte secondary battery refers to a secondary battery in which an electrolyte layer between a positive electrode and a negative electrode contains a polymer. Polymer electrolyte secondary batteries include a dry (or intrinsic) polymer electrolyte battery and a polymer gel electrolyte battery. A polymer electrolyte secondary battery may be referred to as a semi-solid-state battery.

A semi-solid-state battery manufactured using the positive electrode active material 811 is a secondary battery having high charge and discharge capacity. The semi-solid-state battery can have high charge and discharge voltages. Alternatively, a highly safe or reliable semi-solid-state battery can be provided.

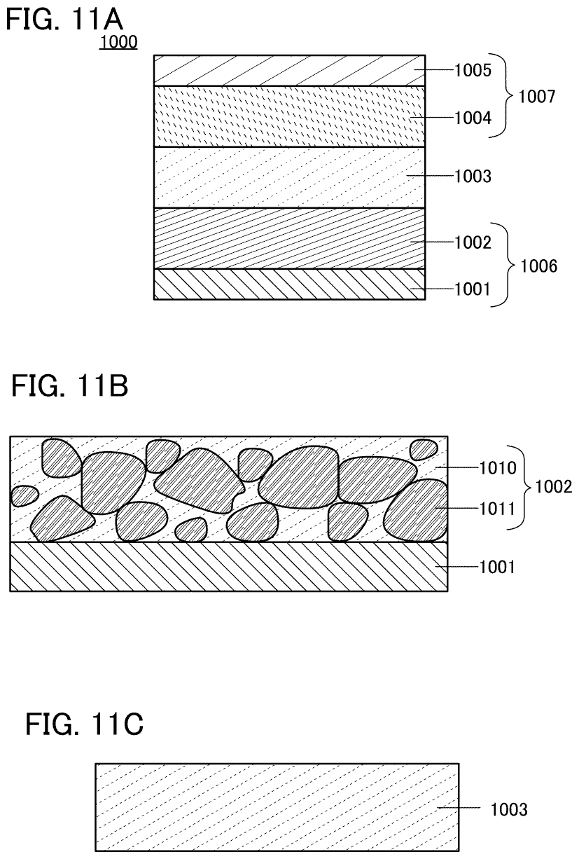

Here, an example in which a semi-solid-state battery is manufactured with the use of a fluorine-containing electrolyte in a positive electrode is described with reference to FIG. 11.

FIG. 11A is a schematic cross-sectional view of a secondary battery 1000 of one embodiment of the present invention. The secondary battery 1000 includes a positive electrode 1006, an electrolyte layer 1003, and a negative electrode 1007. The positive electrode 1006 includes a positive electrode current collector 1001 and a positive electrode active material layer 1002. The negative electrode 1007 includes a negative electrode current collector 1005 and a negative electrode active material layer 1004.

FIG. 11B is a cross-sectional schematic view of the positive electrode 1006. The positive electrode active material layer 1002 of the positive electrode 1006 includes a positive electrode active material 1011, a region 1010, and a conductive material (also referred to as a conductive additive). The region 1010 includes a region among a plurality of positive electrode active materials 1011 or a region between the positive electrode current collector 1001 and the positive electrode active material 1011. The region 1010 contains a fluorine-containing electrolyte, a lithium-ion conductive polymer, and a lithium salt. The region 1010 may include a binder.

FIG. 11C is a schematic cross-sectional view of the electrolyte layer 1003. The electrolyte layer 1003 contains a lithium-ion conductive polymer and a lithium salt.

In this specification and the like, the lithium-ion conductive polymer refers to a polymer having conductivity of cations such as lithium. More specifically, the lithium-ion conductive polymer is a high molecular compound including a polar group to which cations can be coordinated. The polar group is preferably an ether group, an ester group, a nitrile group, a carbonyl group, a siloxane bond, or the like.

As the lithium-ion conductive polymer, for example, polyethylene oxide (PEO), a derivative containing polyethylene oxide as its main chain, polypropylene oxide, polyacrylic acid ester, polymethacrylic acid ester, polysiloxane, polyphosphazene, or the like can be used.

The lithium-ion conductive polymer may have a branched or cross-linking structure. Alternatively, the lithium-ion conductive polymer may be a copolymer. The molecular weight is preferably greater than or equal to ten thousand, further preferably greater than or equal to hundred thousand, for example.

In the lithium-ion conductive polymer, lithium ions move by changing polar groups to interact with, due to the local motion (also referred to as segmental motion) of polymer chains. In PEO, for example, lithium ions move by changing oxygen to interact with, due to the segmental motion of ether chains. When the temperature is close to or higher than the melting point or softening point of the lithium-ion conductive polymer, the crystal regions melt to increase amorphous regions, so that the motion of the ether chains becomes active and the ion conductivity increases. Thus, in the case where PEO is used as the lithium-ion conductive polymer, charging and discharging are preferably performed at higher than or equal to 60° C.

According to the ionic radius of Shannon (Shannon et al., Acta A 32 (1976) 751.), the radius of a monovalent lithium ion is 0.590×10⁻¹⁰ m in the case of tetracoordination, 0.76×10⁻¹⁰ m in the case of hexacoordination, and 0.92×10⁻¹⁰ m in the case of octacoordination. The radius of a bivalent oxygen ion is 1.35×10⁻¹⁰ m in the case of bicoordination, 1.36×10⁻¹⁰ m in the case of tricoordination, 1.38×10⁻¹⁰ m in the case of tetracorrdination, 1.40×10⁻¹⁰ m in the case of hexacoordination, and 1.42×10⁻¹⁰ m in the case of octacoordination. The distance between polar groups included in adjacent lithium-ion conductive polymer chains is preferably greater than or equal to the distance that allows lithium ions and anions contained in the polar groups to exist stably while the above ionic radius is maintained. Furthermore, the distance between the polar groups is preferably close enough to cause interaction between the lithium ions and the polar groups. Note that the distance is not necessarily always kept constant because the segmental motion occurs as described above. The distance needs to be appropriate only when lithium ions are transferred.

As the lithium salt, for example, it is possible to use a compound containing lithium and at least one of phosphorus, fluorine, nitrogen, sulfur, oxygen, chlorine, arsenic, boron, aluminum, bromine, and iodine. For example, one of lithium salts such as LiPF₆, LiN(FSO₂)₂ (lithium bis(fluorosulfonyl)imide, LiFSI), LiClO₄, LiAsF₆, LiBF₄, LiAlCl₄, LiSCN, LiBr, LiI, Li₂SO₄, Li₂B₁₀Cl₁₀, Li₂B₁₂Cl₁₂, LiCF₃SO₃, LiC₄F₉SO₃, LiC(CF₃SO₂)₃, LiC(C₂F₅SO₂)₃, LiN(CF₃SO₂)₂, LiN(C₄F₉SO₂) (CF₃SO₂), LiN(C₂F₅SO₂)₂, and lithium bis(oxalate)borate (LiBOB) can be used, or two or more of these lithium salts can be used in an appropriate combination at an appropriate ratio.

It is particularly preferable to use LiFSI because favorable characteristics at low temperatures can be obtained. Note that LiFSI and LiTFSA are less likely to react with water than LiPF₆ or the like. This can relax the dew point control in fabricating an electrode and an electrolyte layer that use LiFSI. For example, the fabrication can be performed even in a normal air atmosphere, not only in an inert atmosphere of argon or the like in which moisture is excluded as much as possible or in a dry room in which a dew point is controlled. This is preferable because the productivity can be improved. When the segmental motion of ether chains is used for lithium conduction, it is particularly preferable to use a lithium salt that is highly dissociable and has a plasticizing effect, such as LiFSI and LiTFSA, in which case the operating temperature range can be wide.

In this specification and the like, a binder refers to a high molecular compound mixed only for binding an active material, a conductive material, and the like onto a current collector. A binder refers to, for example, a rubber material such as poly vinylidene difluoride (PVDF), styrene-butadiene rubber (SBR), styrene-isoprene-styrene rubber, butadiene rubber, or ethylene-propylene-diene copolymer; or a material such as fluorine rubber, polystyrene, polyvinyl chloride, polytetrafluoroethylene, polyethylene, polypropylene, polyisobutylene, or an ethylene-propylene-diene polymer.

Since the lithium-ion conductive polymer is a high molecular compound, the positive electrode active material 1011 and the conductive material can be bound onto the positive electrode current collector 1001 when the lithium-ion conductive polymer is sufficiently mixed in the positive electrode active material layer 1002. Thus, the positive electrode 1006 can be fabricated without a binder. A binder is a material that does not contribute to charge and discharge reactions. Thus, a smaller amount of the binder enables a higher proportion of materials that contribute to charging and discharging, such as an active material and an electrolyte. As a result, the secondary battery 1000 can have higher discharge capacity, improved cycle performance, or the like.

When containing no or extremely little organic solvent, the secondary battery can be less likely to catch fire and ignite and thus can have higher level of safety, which is preferable. When the electrolyte layer 1003 contains no or extremely little organic solvent, the electrolyte layer 1003 can have enough strength and thus can electrically insulate the positive electrode from the negative electrode without a separator. Since a separator is not necessary, the secondary battery can have high productivity. When the electrolyte layer 1003 contains an inorganic filler, the secondary battery can have higher strength and higher level of safety.

To obtain the electrolyte layer 1003 containing no or extremely little organic solvent, the electrolyte layer 1003 is preferably dried sufficiently. In this specification and the like, the electrolyte layer 1003 can be regarded as being dried sufficiently when a change in the weight after drying at 90° C. under reduced pressure for one hour is within 5%.

Note that materials contained in a secondary battery, such as a lithium-ion conductive polymer, a lithium salt, a binder, and an additive agent can be identified using nuclear magnetic resonance (NMR), for example. Analysis results of Raman spectroscopy, Fourier transform infrared spectroscopy (FT-IR), time-of-flight secondary ion mass spectrometry (TOF-SIMS), gas chromatography mass spectroscopy (GC/MS), pyrolysis gas chromatography mass spectroscopy (Py-GC/MS), liquid chromatography mass spectroscopy (LC/MS), or the like can also be used for the identification. Note that analysis by NMR or the like is preferably performed after the positive electrode active material layer 1002 is subjected to suspension using a solvent to separate the positive electrode active material 1011 from the other materials.

### [Negative Electrode]

The negative electrode includes a negative electrode active material layer and a negative electrode current collector. The negative electrode active material layer may include a conductive additive and a binding agent.

### <Negative Electrode Active Material>

As the negative electrode active material, for example, an alloy-based material, a carbon-based material, or the like can be used. The negative electrode active material used for the secondary battery of one embodiment of the present invention particularly preferably contains fluorine as a halogen. Fluorine has high electronegativity, and the negative electrode active material containing fluorine in its surface portion may have an effect of facilitating extraction of the solvating solvent at the surface of the negative electrode active material.

As the negative electrode active material, an element that enables charge and discharge reactions by alloying and dealloying reactions with lithium can be used. For example, a material containing at least one of silicon, tin, gallium, aluminum, germanium, lead, antimony, bismuth, silver, zinc, cadmium, indium, and the like can be used. Such elements have higher capacity than carbon. In particular, silicon has a high theoretical capacity of 4200 mAh/g. For this reason, silicon is preferably used as the negative electrode active material. Alternatively, a compound containing any of the above elements may be used. For example, SiO, Mg₂Si, Mg₂Ge, SnO, SnO₂, Mg₂Sn, SnS₂, V₂Sn₃, FeSn₂, CoSn₂, Ni₃Sn₂, Cu₆Sn₅, Ag₃Sn, Ag₃Sb, Ni₂MnSb, CeSb₃, LaSn₃, La₃Co₂Sn₇, CoSb₃, InSb, and SbSn are given. Here, an element that enables charge and discharge reactions by alloying and dealloying reactions with lithium, a compound containing the element, and the like may be referred to as an alloy-based material.

In this specification and the like, SiO refers to silicon monoxide, for example. Note that SiO can alternatively be expressed as SiOₓ. Here, it is preferred that x be 1 or have an approximate value of 1. For example, x is preferably more than or equal to 0.2 and less than or equal to 1.5, and preferably more than or equal to 0.3 and less than or equal to 1.2.

As the carbon-based material, graphite, graphitizing carbon (soft carbon), non-graphitizing carbon (hard carbon), carbon nanotube, graphene, carbon black, or the like can be used. Such a carbon-based material preferably contains fluorine. A carbon-based material containing fluorine can also be referred to as a particulate or fibrous fluorocarbon material. In the case where the carbon-based material is subjected to measurement by X-ray photoelectron spectroscopy, the concentration of fluorine is preferably higher than or equal to 1 atomic % with respect to the total concentration of fluorine, oxygen, lithium, and carbon.

Examples of graphite include artificial graphite and natural graphite. Examples of artificial graphite include mesocarbon microbeads (MCMB), coke-based artificial graphite, and pitch-based artificial graphite. Here, as artificial graphite, spherical graphite having a spherical shape can be used. For example, MCMB is preferable because it may have a spherical shape. Moreover, MCMB may be preferable because it can relatively easily have a small surface area. Examples of natural graphite include flake graphite and spherical natural graphite.

Graphite has a low potential substantially equal to that of a lithium metal (higher than or equal to 0.05 V and lower than or equal to 0.3 V vs. Li/Li⁺) when lithium ions are inserted into the graphite (while a lithium-graphite intercalation compound is generated). For this reason, a lithium-ion secondary battery can have a high operating voltage. In addition, graphite is preferred because of its advantages such as a relatively high capacity per unit volume, relatively small volume expansion, low cost, and higher level of safety than that of a lithium metal.

As the negative electrode active material, an oxide such as titanium dioxide (TiO₂), lithium titanium oxide (Li₄Ti₅O₁₂), a lithium-graphite intercalation compound (LiₓC₆), niobium pentoxide (Nb₂O₅), tungsten oxide (WO₂), or molybdenum oxide (MoO₂) can be used.

Alternatively, as the negative electrode active material, Li₃₋ₓMₓN (M=Co, Ni, Cu) with a Li₃N structure, which is a composite nitride containing lithium and a transition metal, can be used. For example, Li_{2.6}Co_{0.4}N₃ is preferable because of high charge and discharge capacity (900 mAh/g and 1890 mAh/cm³).

A composite nitride containing lithium and a transition metal is preferably used, in which case lithium ions are contained in the negative electrode active material and thus the negative electrode active material can be used in combination with a positive electrode active material that does not contain lithium ions, such as V₂O₅ or Cr₃O₈. Note that in the case of using a material containing lithium ions as a positive electrode active material, the composite nitride containing lithium and a transition metal can be used as the negative electrode active material by extracting the lithium ions contained in the positive electrode active material in advance.

Alternatively, a material that causes a conversion reaction can be used as the negative electrode active material. For example, a transition metal oxide that does not form an alloy with lithium, such as cobalt oxide (CoO), nickel oxide (NiO), and iron oxide (FeO), may be used as the negative electrode active material. A conversion reaction also occurs in oxides such as Fe₂O₃, CuO, Cu₂O, RuO₂, and Cr₂O₃, sulfides such as CoS_{0.89}, NiS, and CuS, nitrides such as Zn₃N₂, Cu₃N, and Ge₃N₄, phosphides such as NiP₂, FeP₂, and CoP₃, and fluorides such as FeF₃ and BiF₃.

### [Fluorine Modified Conductive Agent]

Here, the conductive agent is preferably modified with fluorine in the negative electrode of one embodiment of the present invention. For example, as the conductive agent, a material obtained by modification of the above-described conductive agent with fluorine can be used.

The conductive agent can be modified with fluorine through treatment or heat treatment using a fluorine-containing gas or plasma treatment in a fluorine-containing gas atmosphere, for example. As the fluorine-containing gas, for example, a fluorine gas or a lower hydrofluorocarbon gas such as fluoromethane (CF₄) can be used.

Alternatively, the conductive agent may be modified with fluorine through immersion in a solution containing hydrofluoric acid, tetrafluoroboric acid, hexafluorophosphoric acid, or the like or a solution containing a fluorine-containing ether compound, for example.

Modification of the conductive agent with fluorine is expected to stabilize the structure and suppress a side reaction in charging and discharging process of a secondary battery. The suppression of the side reaction can improve charge and discharge efficiency. In addition, a decrease in capacity caused by repetitive charging and discharging can be suppressed. Thus, when the negative electrode of one embodiment of the present invention includes a conductive agent that is modified with fluorine, an excellent secondary battery can be achieved.

In some cases, stabilization of the structure of the conductive agent stabilizes conductive characteristics, leading to high output characteristics.

### <Negative Electrode Current Collector>

For the negative electrode current collector, a material similar to that of the positive electrode current collector can be used. Note that a material that is not alloyed with carrier ions of lithium or the like is preferably used for the negative electrode current collector.

### [Separator]

A separator may be positioned between the positive electrode and the negative electrode. The separator is formed using a porous material having a hole with a size of approximately 20 nm, preferably a hole with a size of greater than or equal to 6.5 nm, further preferably a hole with a diameter of at least 2 nm. In the case of the above-described semi-solid-state secondary battery, a separator can be omitted. The separator can be formed using, for example, a fiber containing cellulose, such as paper, nonwoven fabric, glass fiber, ceramics, or synthetic fiber containing nylon (polyamide), vinylon (polyvinyl alcohol-based fiber), polyester, acrylic, polyolefin, or polyurethane. The separator is preferably processed into a bag-like shape to enclose one of the positive electrode and the negative electrode.

The separator may have a multilayer structure. For example, an organic material film of polypropylene, polyethylene, or the like can be coated with a ceramic-based material, a fluorine-based material, a polyamide-based material, a mixture thereof, or the like. Examples of the ceramic-based material include aluminum oxide particles and silicon oxide particles. Examples of the fluorine-based material include PVDF and polytetrafluoroethylene. Examples of the polyamide-based material include nylon and aramid (meta-based aramid and para-based aramid).

When the separator is coated with the ceramic-based material, the oxidation resistance is improved; hence, deterioration of the separator in charging and discharging at high voltage can be suppressed and thus the reliability of the secondary battery can be improved. When the separator is coated with the fluorine-based material, the separator is easily brought into close contact with an electrode, resulting in high output characteristics. When the separator is coated with the polyamide-based material, in particular, aramid, the safety of the secondary battery is improved because heat resistance is improved.

For example, both surfaces of a polypropylene film may be coated with a mixed material of aluminum oxide and aramid. Alternatively, a surface of a polypropylene film that is in contact with the positive electrode may be coated with a mixed material of aluminum oxide and aramid, and a surface of the polypropylene film that is in contact with the negative electrode may be coated with the fluorine-based material.

With the use of a separator having a multilayer structure, the capacity per volume of the secondary battery can be increased because the safety of the secondary battery can be maintained even when the total thickness of the separator is small.

The secondary battery can be manufactured using any of the above structures in appropriate combination.

This embodiment can be implemented in appropriate combination with any of the other embodiments.

### Embodiment 3

This embodiment describes examples of shapes of several types of secondary batteries including a positive electrode or a negative electrode formed by the manufacturing method described in the foregoing embodiment.

### [Coin-Type Secondary Battery]

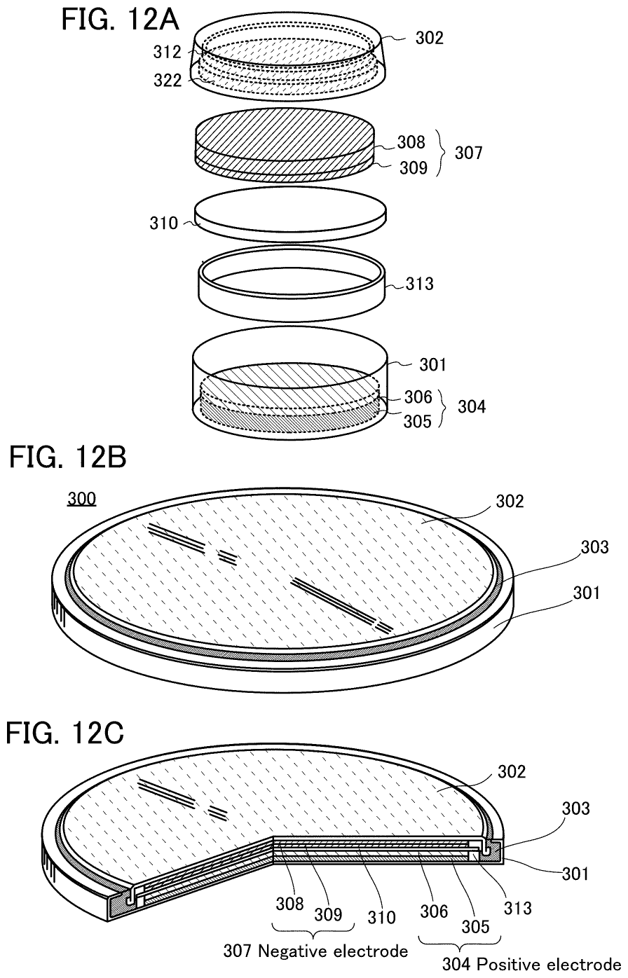

An example of a coin-type secondary battery is described. FIG. 12A is an exploded perspective view of a coin-type (single-layer flat type) secondary battery, FIG. 12B is an external view thereof, and FIG. 12C is a cross-sectional view thereof. Coin-type secondary batteries are mainly used in small electronic devices.

For easy understanding, FIG. 12A is a schematic view showing overlap (a vertical relation and a positional relation) between components. Thus, FIG. 12A and FIG. 12B do not completely correspond with each other.

In FIG. 12A, a positive electrode 304, a separator 310, a negative electrode 307, a spacer 322, and a washer 312 are overlaid. They are sealed with a negative electrode can 302 and a positive electrode can 301. Note that a gasket for sealing is not illustrated in FIG. 12A. The spacer 322 and the washer 312 are used to protect the inside or fix the position inside the cans at the time when the positive electrode can 301 and the negative electrode can 302 are bonded with pressure. For the spacer 322 and the washer 312, stainless steel or an insulating material is used.

The positive electrode 304 has a stack structure in which a positive electrode active material layer 306 is formed over a positive electrode current collector 305.

To prevent a short circuit between the positive electrode and the negative electrode, the separator 310 and a ring-shaped insulator 313 are provided to cover the side surface and top surface of the positive electrode 304. The separator 310 has a larger flat surface area than the positive electrode 304.

FIG. 12B is a perspective view of a manufactured coin-type secondary battery.

In a coin-type secondary battery 300, the positive electrode can 301 doubling as a positive electrode terminal and the negative electrode can 302 doubling as a negative electrode terminal are insulated from each other and sealed by a gasket 303 made of polypropylene or the like. The positive electrode 304 includes the positive electrode current collector 305 and the positive electrode active material layer 306 provided in contact with the positive electrode current collector 305. The negative electrode 307 includes a negative electrode current collector 308 and a negative electrode active material layer 309 provided in contact with the negative electrode current collector 308. The negative electrode 307 is not limited to having a stacked-layer structure, and lithium metal foil or lithium-aluminum alloy foil may be used.

Note that only one surface of each of the positive electrode 304 and the negative electrode 307 used for the coin-type secondary battery 300 is provided with an active material layer.

For the positive electrode can 301 and the negative electrode can 302, a metal having corrosion resistance to an electrolyte, such as nickel, aluminum, or titanium, an alloy of such a metal, or an alloy of such a metal and another metal (e.g., stainless steel) can be used. The positive electrode can 301 and the negative electrode can 302 are preferably covered with nickel, aluminum, or the like in order to prevent corrosion due to the electrolyte. The positive electrode can 301 and the negative electrode can 302 are electrically connected to the positive electrode 304 and the negative electrode 307, respectively.

The coin-type secondary battery 300 is manufactured in the following manner: the negative electrode 307, the positive electrode 304, and the separator 310 are immersed in the electrolyte; as illustrated in FIG. 12C, the positive electrode 304, the separator 310, the negative electrode 307, and the negative electrode can 302 are stacked in this order with the positive electrode can 301 positioned at the bottom; and then the positive electrode can 301 and the negative electrode can 302 are subjected to pressure bonding with the gasket 303 therebetween.

The secondary battery can be the coin-type secondary battery 300 having high capacity, high charge and discharge capacity, and excellent cycle performance. Note that in the case of a secondary battery, the separator 310 is not necessarily provided between the negative electrode 307 and the positive electrode 304.

### [Cylindrical Secondary Battery]

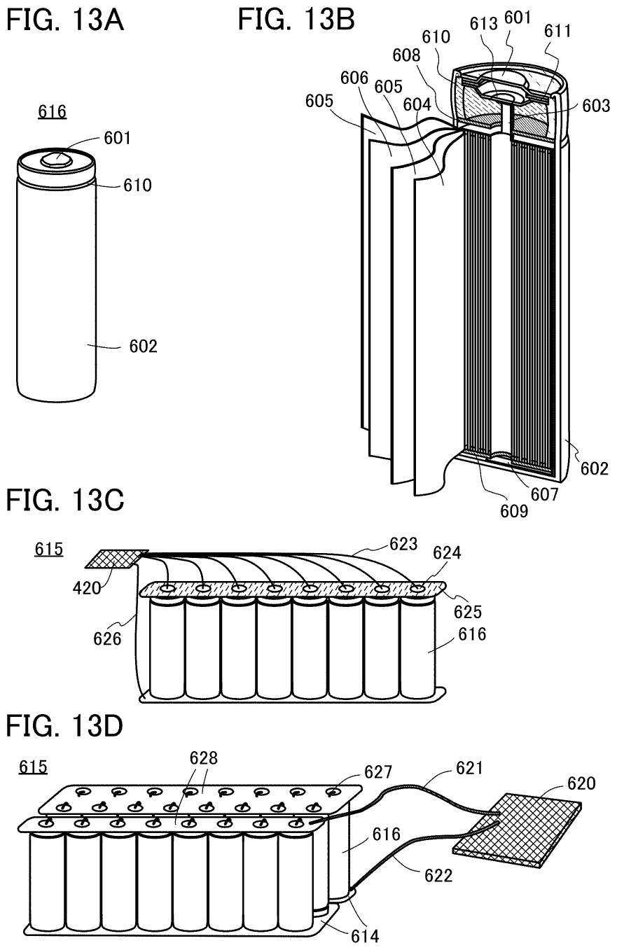

An example of a cylindrical secondary battery is described with reference to FIG. 13A. As illustrated in FIG. 13A, a cylindrical secondary battery 616 includes a positive electrode cap (battery cap) 601 on the top surface and a battery can (outer can) 602 on the side surface and bottom surface. The battery can (outer can) 602 is formed using a metal material and has an excellent barrier property against water permeation and an excellent gas barrier property. The positive electrode cap 601 and the battery can (outer can) 602 are insulated from each other by a gasket (insulating gasket) 610.

FIG. 13B schematically illustrates a cross section of a cylindrical secondary battery. The cylindrical secondary battery illustrated in FIG. 13B includes the positive electrode cap (battery cap) 601 on the top surface and the battery can (outer can) 602 on the side surface and the bottom surface. The positive electrode cap and the battery can (outer can) 602 are insulated from each other by the gasket (insulating gasket) 610.

Inside the battery can 602 having a hollow cylindrical shape, a battery element in which a strip-like positive electrode 604 and a strip-like negative electrode 606 are wound with a strip-like separator 605 located therebetween is provided. Although not illustrated, the battery element is wound around a center pin. One end of the battery can 602 is close and the other end thereof is open. For the battery can 602, a metal having corrosion resistance to an electrolyte, such as nickel, aluminum, or titanium, an alloy of such a metal, or an alloy of such a metal and another metal (e.g., stainless steel) can be used. The battery can 602 is preferably covered with nickel, aluminum, or the like in order to prevent corrosion due to the electrolyte. Inside the battery can 602, the battery element in which the positive electrode, the negative electrode, and the separator are wound is provided between a pair of insulating plates 608 and 609 that face each other. The inside of the battery can 602 provided with the battery element is filled with an electrolyte (not illustrated). An electrolyte similar to that for the coin-type secondary battery can be used.

Since a positive electrode and a negative electrode that are used for a cylindrical storage battery are wound, active materials are preferably formed on both surfaces of a current collector.

The positive electrode obtained in Embodiment 1 is used, whereby the cylindrical secondary battery 616 can have high capacity, high charge and discharge capacity, and excellent cycle performance.

A positive electrode terminal (positive electrode current collecting lead) 603 is connected to the positive electrode 604, and a negative electrode terminal (negative electrode current collecting lead) 607 is connected to the negative electrode 606. Both the positive electrode terminal 603 and the negative electrode terminal 607 can be formed using a metal material such as aluminum. The positive electrode terminal 603 and the negative electrode terminal 607 are resistance-welded to a safety valve mechanism 613 and the bottom of the battery can 602, respectively. The safety valve mechanism 613 is electrically connected to the positive electrode cap 601 through a PTC element (Positive Temperature Coefficient) 611. The safety valve mechanism 613 cuts off electrical connection between the positive electrode cap 601 and the positive electrode 604 when the internal pressure of the battery exceeds a predetermined threshold. The PTC element 611, which is a thermally sensitive resistor whose resistance increases as temperature rises, limits the amount of current by increasing the resistance, in order to prevent abnormal heat generation. Barium titanate (BaTiO₃)-based semiconductor ceramic or the like can be used for the PTC element.

FIG. 13C shows an example of a power storage system 615. The power storage system 615 includes a plurality of secondary batteries 616. The positive electrodes of the secondary batteries are in contact with and electrically connected to conductors 624 isolated by an insulator 625. The conductor 624 is electrically connected to a control circuit 620 through a wiring 623. The negative electrodes of the secondary batteries are electrically connected to the control circuit 620 through a wiring 626. As the control circuit 620, a charging and discharging control circuit for performing charging, discharging, and the like or a protection circuit for preventing overcharging or overdischarging can be used.

FIG. 13D shows an example of the power storage system 615. The power storage system 615 includes the plurality of secondary batteries 616, and the plurality of secondary batteries 616 are sandwiched between a conductive plate 628 and a conductive plate 614. The plurality of secondary batteries 616 are electrically connected to the conductive plate 628 and the conductive plate 614 through a wiring 627. The plurality of secondary batteries 616 may be connected in parallel, connected in series, or connected in series after being connected in parallel. With the power storage system 615 including the plurality of secondary batteries 616, large electric power can be extracted.

The plurality of secondary batteries 616 may be connected in series after being connected in parallel.

A temperature control device may be provided between the plurality of secondary batteries 616. The secondary batteries 616 can be cooled with the temperature control device when overheated, whereas the secondary batteries 616 can be heated with the temperature control device when cooled too much. Thus, the performance of the power storage system 615 is less likely to be influenced by the outside temperature.

In FIG. 13D, the power storage system 615 is electrically connected to the control circuit 620 through a wiring 621 and a wiring 622. The wiring 621 is electrically connected to the positive electrodes of the plurality of secondary batteries 616 through the conductive plate 628. The wiring 622 is electrically connected to the negative electrodes of the plurality of secondary batteries 616 through the conductive plate 614.

### [Other Structure Examples of Secondary Battery]

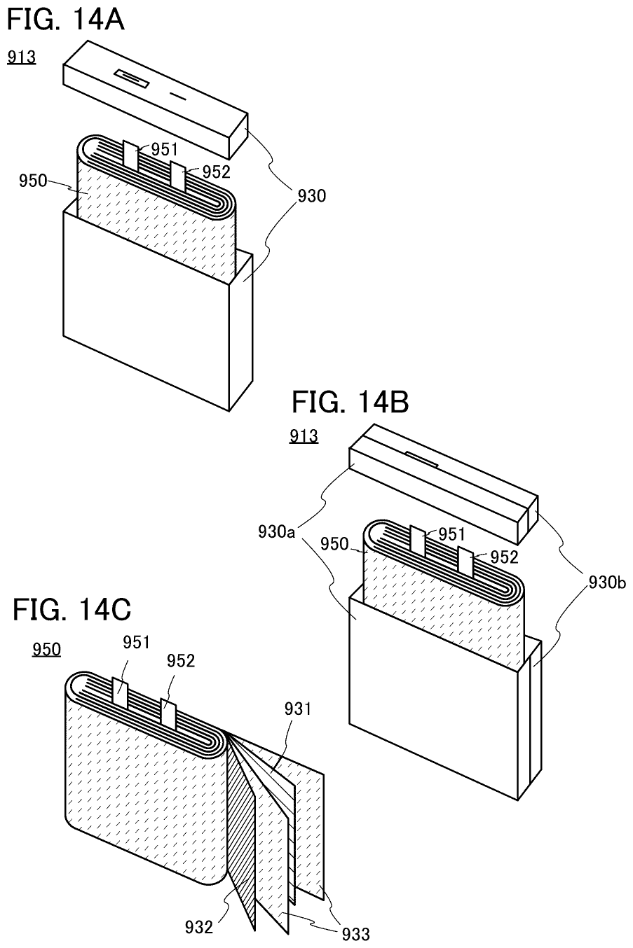

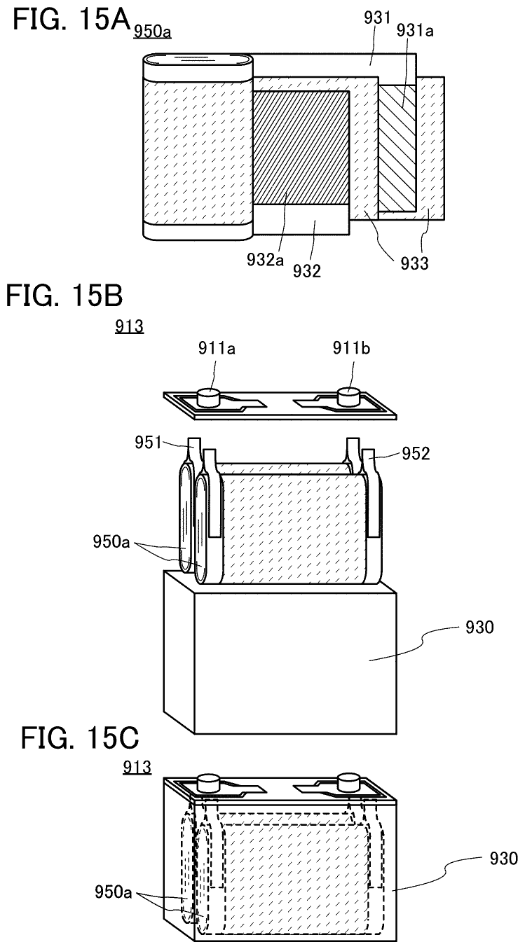

Structure examples of secondary batteries are described with reference to FIG. 14 and FIG. 15.

A secondary battery 913 illustrated in FIG. 14A includes a wound body 950 provided with a terminal 951 and a terminal 952 inside a housing 930. The wound body 950 is immersed in an electrolyte inside the housing 930. The terminal 952 is in contact with the housing 930. The use of an insulator or the like inhibits contact between the terminal 951 and the housing 930. Note that in FIG. 14A, the housing 930 divided into pieces is illustrated for convenience; however, in the actual structure, the wound body 950 is covered with the housing 930, and the terminal 951 and the terminal 952 extend to the outside of the housing 930. For the housing 930, a metal material (e.g., aluminum) or a resin material can be used.

Note that as illustrated in FIG. 14B, the housing 930 in FIG. 14A may be formed using a plurality of materials. For example, in the secondary battery 913 illustrated in FIG. 14B, a housing 930a and a housing 930b are attached to each other, and the wound body 950 is provided in a region surrounded by the housing 930a and the housing 930b.

For the housing 930a, an insulating material such as an organic resin can be used. In particular, when a material such as an organic resin is used for the side on which an antenna is formed, blocking of an electric field by the secondary battery 913 can be inhibited. When an electric field is not significantly blocked by the housing 930a, an antenna may be provided inside the housing 930a. For the housing 930b, a metal material can be used, for example.

FIG. 14C illustrates the structure of the wound body 950. The wound body 950 includes a negative electrode 931, a positive electrode 932, and separators 933. The wound body 950 is obtained by winding a sheet of a stack in which the negative electrode 931 and the positive electrode 932 overlap with each other with the separator 933 therebetween. Note that a plurality of stacks each including the negative electrode 931, the positive electrode 932, and the separators 933 may be further stacked.

As illustrated in FIG. 15, the secondary battery 913 may include a wound body 950a. The wound body 950a illustrated in FIG. 15A includes the negative electrode 931, the positive electrode 932, and the separators 933. The negative electrode 931 includes a negative electrode active material layer 931a. The positive electrode 932 includes a positive electrode active material layer 932a.

The positive electrode structure obtained in Embodiment 1, i.e., the structure including the fluorine-containing electrolyte in the positive electrode, is employed, and the positive electrode active material 811 obtained in Embodiment 2 is used for the positive electrode 932, whereby the secondary battery 913 can have high capacity, high charge and discharge capacity, and excellent cycle performance.

The separator 933 has a larger width than the negative electrode active material layer 931a and the positive electrode active material layer 932a, and is wound to overlap with the negative electrode active material layer 931a and the positive electrode active material layer 932a. In terms of safety, the width of the negative electrode active material layer 931a is preferably larger than that of the positive electrode active material layer 932a. The wound body 950a having such a shape is preferable because of its high degree of safety and high productivity.

As illustrated in FIG. 15A and FIG. 15B, the negative electrode 931 is electrically connected to the terminal 951. The terminal 951 is electrically connected to a terminal 911a. The positive electrode 932 is electrically connected to the terminal 952. The terminal 952 is electrically connected to a terminal 911b.

As illustrated in FIG. 15C, the wound body 950a and an electrolyte are covered with the housing 930, whereby the secondary battery 913 is completed. The housing 930 is preferably provided with a safety valve, an overcurrent protection element, and the like. In order to prevent the battery from exploding, a safety valve is a valve to be released when the internal pressure of the housing 930 reaches a predetermined pressure.

As illustrated in FIG. 15B, the secondary battery 913 may include a plurality of wound bodies 950a. The use of the plurality of wound bodies 950a enables the secondary battery 913 to have higher charge and discharge capacity. The description of the secondary battery 913 illustrated in FIG. 14A to FIG. 14C can be referred to for the other components of the secondary battery 913 illustrated in FIG. 15A and FIG. 15B.

### <Laminated Secondary Battery>

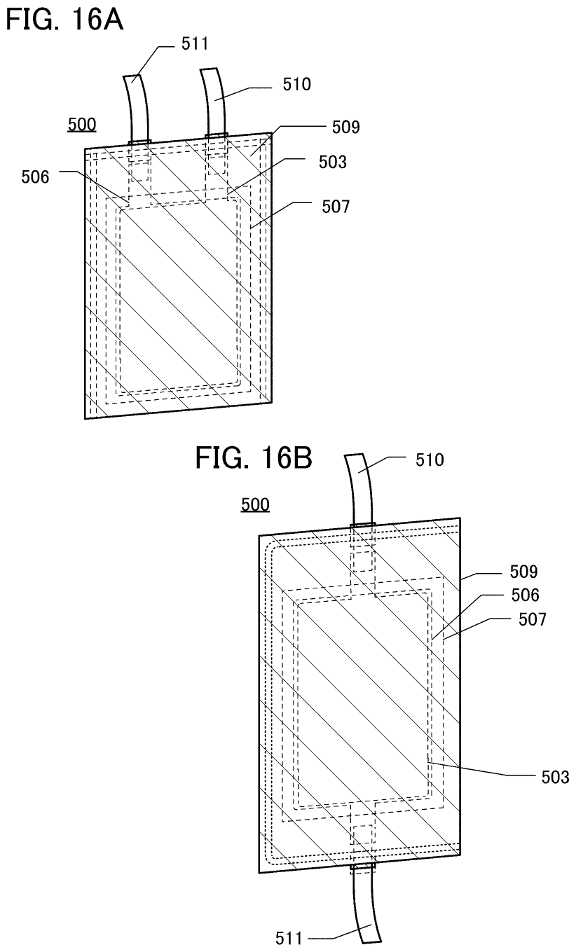

Next, examples of the appearance of a laminated secondary battery are shown in FIG. 16A and FIG. 16B. FIG. 16A and FIG. 16B each include a positive electrode 503, a negative electrode 506, a separator 507, an exterior body 509, a positive electrode lead electrode 510, and a negative electrode lead electrode 511.

FIG. 16A illustrates the appearance of the positive electrode 503 and the negative electrode 506. The positive electrode 503 includes a positive electrode current collector 501, and a positive electrode active material layer 502 is formed on a surface of the positive electrode current collector 501. The positive electrode 503 also includes a region where the positive electrode current collector 501 is partly exposed (hereinafter referred to as a tab region). The negative electrode 506 includes a negative electrode current collector 504, and a negative electrode active material layer 505 is formed on a surface of the negative electrode current collector 504. The negative electrode 506 also includes a region where the negative electrode current collector 504 is partly exposed, that is, a tab region. The areas and the shapes of the tab regions included in the positive electrode and the negative electrode are not limited to the examples shown in FIG. 16A.

### <Method for Manufacturing Laminated Secondary Battery>

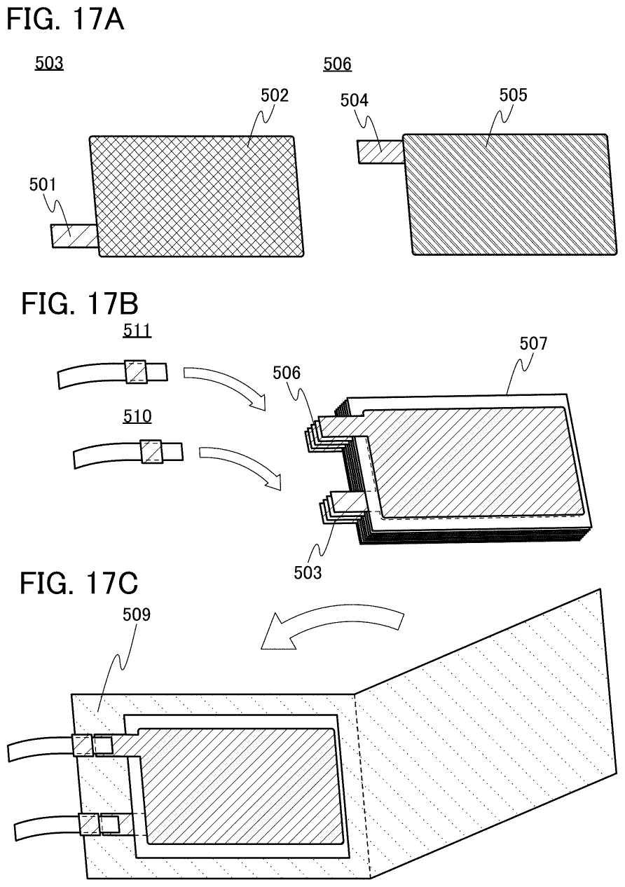

Here, an example of a method for manufacturing the laminated secondary battery whose external view is shown in FIG. 16A is described with reference to FIG. 17B and FIG. 17C.

First, the negative electrode 506, the separator 507, and the positive electrode 503 are stacked. FIG. 17B illustrates the negative electrodes 506, the separators 507, and the positive electrodes 503 that are stacked. Here, an example in which five negative electrodes and four positive electrodes are used is shown. The component can also be referred to as a stack including the negative electrodes, the separators, and the positive electrodes. Next, the tab regions of the positive electrodes 503 are bonded to each other, and the positive electrode lead electrode 510 is bonded to the tab region of the positive electrode on the outermost surface. The bonding can be performed by ultrasonic welding, for example. In a similar manner, the tab regions of the negative electrodes 506 are bonded to each other, and the negative electrode lead electrode 511 is bonded to the tab region of the negative electrode on the outermost surface.

Then, the negative electrodes 506, the separators 507, and the positive electrodes 503 are placed over the exterior body 509.

Subsequently, the exterior body 509 is folded along a portion shown by a dashed line, as illustrated in FIG. 17C. Then, the outer edges of the exterior body 509 are bonded to each other. The bonding can be performed by thermocompression, for example. At this time, an unbonded region (hereinafter referred to as an inlet) is provided for part (or one side) of the exterior body 509 so that an electrolyte 508 can be introduced later. As the exterior body 509, a film having an excellent barrier property against water permeation and an excellent gas barrier property is preferably used. The exterior body 509 having a stacked-layer structure including metal foil (for example, aluminum foil) as one of intermediate layers can have a high barrier property against water permeation and a high gas barrier property.

Next, the electrolyte 508 (not illustrated) is introduced into the exterior body 509 from the inlet of the exterior body 509. The electrolyte 508 is preferably introduced in a reduced pressure atmosphere or in an inert atmosphere. Lastly, the inlet is sealed by bonding. In this manner, the laminated secondary battery 500 can be manufactured.

The positive electrode structure obtained in Embodiment 1, i.e., the structure including the fluorine-containing electrolyte in the positive electrode, is employed, and the positive electrode active material 811 obtained in Embodiment 2 is used for the positive electrode 503, whereby the secondary battery 500 can have high capacity, high charge and discharge capacity, and excellent cycle performance.

This embodiment can be implemented in appropriate combination with any of the other embodiments.

### Embodiment 4

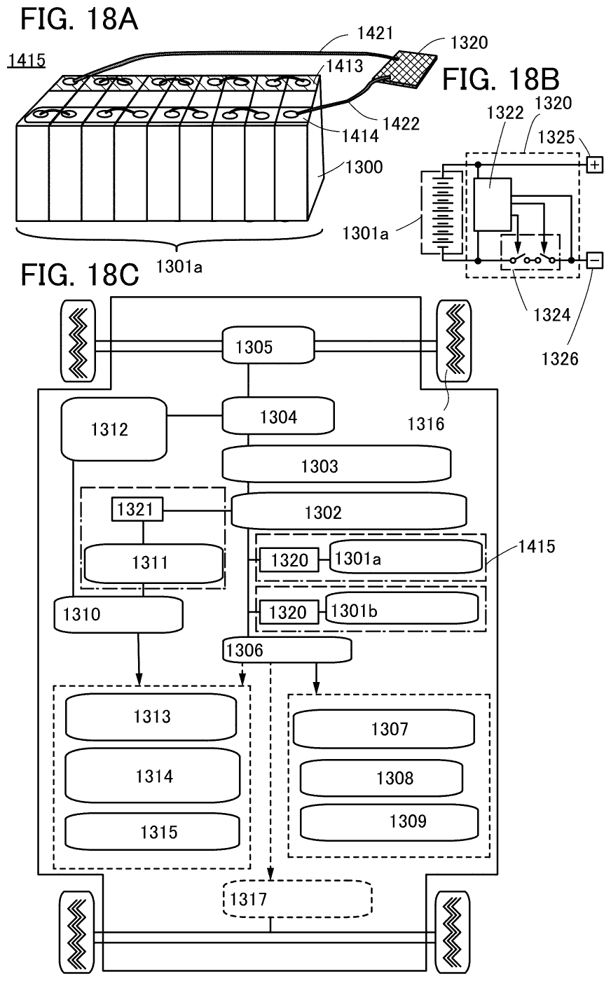

An example which is different from the cylindrical secondary battery in FIG. 13D is described in this embodiment. An example in which the present invention is applied to an electric vehicle (EV) is described with reference to FIG. 18C.

The electric vehicle is provided with first batteries 1301a and 1301b as main secondary batteries for driving and a second battery 1311 that supplies electric power to an inverter 1312 for starting a motor 1304. The second battery 1311 is also referred to as a cranking battery (also referred to as a starter battery). The second battery 1311 needs high output and high capacity is not so necessary, and the capacity of the second battery 1311 is lower than that of the first batteries 1301a and 1301b.

The internal structure of the first battery 1301a may be the wound structure illustrated in FIG. 14A or the stacked structure illustrated in FIG. 16A and FIG. 16B.

Although this embodiment describes an example in which two first batteries 1301a and 1301b are connected in parallel, three or more first batteries may be connected in parallel. When the first battery 1301a is capable of storing sufficient electric power, the first battery 1301b may be omitted. With a battery pack including a plurality of secondary batteries, large electric power can be extracted. The plurality of secondary batteries may be connected in parallel, connected in series, or connected in series after being connected in parallel. The plurality of secondary batteries can also be referred to as an assembled battery.

An in-vehicle secondary battery includes a service plug or a circuit breaker that can cut off high voltage without the use of equipment in order to cut off electric power from a plurality of secondary batteries. The first battery 1301a is provided with such a service plug or a circuit breaker.

Electric power from the first batteries 1301a and 1301b is mainly used to rotate the motor 1304 and is also supplied to in-vehicle parts for 42 V (such as an electric power steering 1307, a heater 1308, and a defogger 1309) through a DC-DC circuit 1306. In the case where there is a rear motor 1317 for the rear wheels, the first battery 1301a is used to rotate the rear motor 1317.

The second battery 1311 supplies electric power to in-vehicle parts for 14 V (such as an audio 1313, power windows 1314, and lamps 1315) through a DC-DC circuit 1310.

The first battery 1301a is described with reference to FIG. 18A.

FIG. 18A shows an example in which nine rectangular secondary batteries 1300 form one battery pack 1415. The nine rectangular secondary batteries 1300 are connected in series; one electrode of each battery is fixed by a fixing portion 1413 made of an insulator, and the other electrode of each battery is fixed by a fixing portion 1414 made of an insulator. Although this embodiment shows the example in which the secondary batteries are fixed by the fixing portions 1413 and 1414, they may be stored in a battery container box (also referred to as a housing). Since a vibration or a jolt is assumed to be given to the vehicle from the outside (e.g., a road surface), the plurality of secondary batteries are preferably fixed by the fixing portions 1413 and 1414 and a battery container box, for example. Furthermore, the one electrode of each battery is electrically connected to a control circuit portion 1320 through a wiring 1421. The other electrode of each battery is electrically connected to the control circuit portion 1320 through a wiring 1422.

The control circuit portion 1320 may include a memory circuit including a transistor using an oxide semiconductor. A charge control circuit or a battery control system that includes a memory circuit including a transistor using an oxide semiconductor may be referred to as a BTOS (Battery operating system or Battery oxide semiconductor).

The control circuit portion 1320 senses a terminal voltage of the secondary battery and controls the charge and discharge state of the secondary battery. For example, to prevent overcharging, the control circuit portion 1320 can turn off an output transistor of a charging circuit and an interruption switch substantially at the same time.

FIG. 18B is an example of a block diagram of the battery pack 1415 illustrated in FIG. 18A.

The control circuit portion 1320 includes a switch portion 1324 that includes at least a switch for preventing overcharging and a switch for preventing overdischarging, a control circuit 1322 for controlling the switch portion 1324, and a portion for measuring the voltage of the first battery 1301a. The control circuit portion 1320 is set to have the upper limit voltage and the lower limit voltage of the secondary battery used, and controls the upper limit of current from the outside, the upper limit of output current to the outside, or the like. The range from the lower limit voltage to the upper limit voltage of the secondary battery is a recommended voltage range, and when a voltage is out of the range, the switch portion 1324 operates and functions as a protection circuit. The control circuit portion 1320 can also be referred to as a protection circuit because it controls the switch portion 1324 to prevent overdischarging and overcharging. For example, when the control circuit 1322 detects a voltage that is likely to cause overcharging, current is interrupted by turning off the switch in the switch portion 1324. Furthermore, a function of interrupting current in accordance with a temperature rise may be set by providing a PTC element in the charge and discharge path. The control circuit portion 1320 includes an external terminal 1325 (+IN) and an external terminal 1326 (—IN).

The switch portion 1324 can be formed by a combination of an n-channel transistor and a p-channel transistor. The switch portion 1324 is not limited to including a switch having a Si transistor using single crystal silicon; the switch portion 1324 may be formed using a power transistor containing Ge (germanium), SiGe (silicon germanium), GaAs (gallium arsenide), GaAlAs (gallium aluminum arsenide), InP (indium phosphide), SiC (silicon carbide), ZnSe (zinc selenide), GaN (gallium nitride), GaOₓ (gallium oxide; x is a real number greater than 0), or the like. A memory element using an OS transistor can be freely placed by being stacked over a circuit using a Si transistor, for example; hence, integration can be easy. Furthermore, an OS transistor can be manufactured with a manufacturing apparatus similar to that for a Si transistor and thus can be manufactured at low cost. That is, the control circuit portion 1320 using OS transistors can be stacked over the switch portion 1324 so that they can be integrated into one chip. Since the area occupied by the control circuit portion 1320 can be reduced, a reduction in size is possible.

The first batteries 1301a and 1301b mainly supply electric power to in-vehicle parts for 42 V (for a high-voltage system), and the second battery 1311 supplies electric power to in-vehicle parts for 14 V (for a low-voltage system).

In this embodiment, an example in which a lithium-ion secondary battery is used as each of the first battery 1301a and the second battery 1311 is described. As the second battery 1311, a lead storage battery, an all-solid-state battery, or an electric double layer capacitor may alternatively be used.

Regenerative energy generated by rolling of tires 1316 is transmitted to the motor 1304 through a gear 1305, and is stored in the second battery 1311 through a motor controller 1303, a battery controller 1302, and a control circuit portion 1321. Alternatively, the regenerative energy is stored in the first battery 1301a through the battery controller 1302 and the control circuit portion 1320. Alternatively, the regenerative energy is stored in the first battery 1301b through the battery controller 1302 and the control circuit portion 1320. For efficient charging with regenerative energy, the first batteries 1301a and 1301b are preferably capable of fast charging.

The battery controller 1302 can set the charge voltage, charge current, and the like of the first batteries 1301a and 1301b. The battery controller 1302 can set charge conditions in accordance with charge characteristics of a secondary battery used, so that fast charging can be performed.

Although not illustrated, when the electric vehicle is connected to an external charger, a plug of the charger or a connection cable of the charger is electrically connected to the battery controller 1302. Electric power supplied from the external charger is stored in the first batteries 1301a and 1301b through the battery controller 1302. Some chargers are provided with a control circuit, in which case the function of the battery controller 1302 is not used; to prevent overcharging, the first batteries 1301a and 1301b are preferably charged through the control circuit portion 1320. In addition, a connection cable or a connection cable of the charger is sometimes provided with a control circuit. The control circuit portion 1320 is also referred to as an ECU (Electronic Control Unit). The ECU is connected to a CAN (Controller Area Network) provided in the electric vehicle. The CAN is a type of a serial communication standard used as an in-vehicle LAN. The ECU includes a microcomputer. Moreover, the ECU uses a CPU or a GPU.

Next, examples in which the secondary battery of one embodiment of the present invention is mounted on a vehicle, typically a transport vehicle, are described.

Mounting the secondary battery illustrated in either FIG. 13D or FIG. 18A on vehicles can achieve next-generation clean energy vehicles such as hybrid vehicles (HVs), electric vehicles (EVs), and plug-in hybrid vehicles (PHVs). The secondary battery can also be mounted on transport vehicles such as agricultural machines, motorized bicycles including motor-assisted bicycles, motorcycles, electric wheelchairs, electric carts, boats and ships, submarines, aircraft such as fixed-wing aircraft and rotary-wing aircraft, rockets, artificial satellites, space probes, planetary probes, and spacecraft. The secondary battery of one embodiment of the present invention can be a secondary battery with high capacity. Thus, the secondary battery of one embodiment of the present invention is suitable for reduction in size and reduction in weight and is preferably used in transport vehicles.

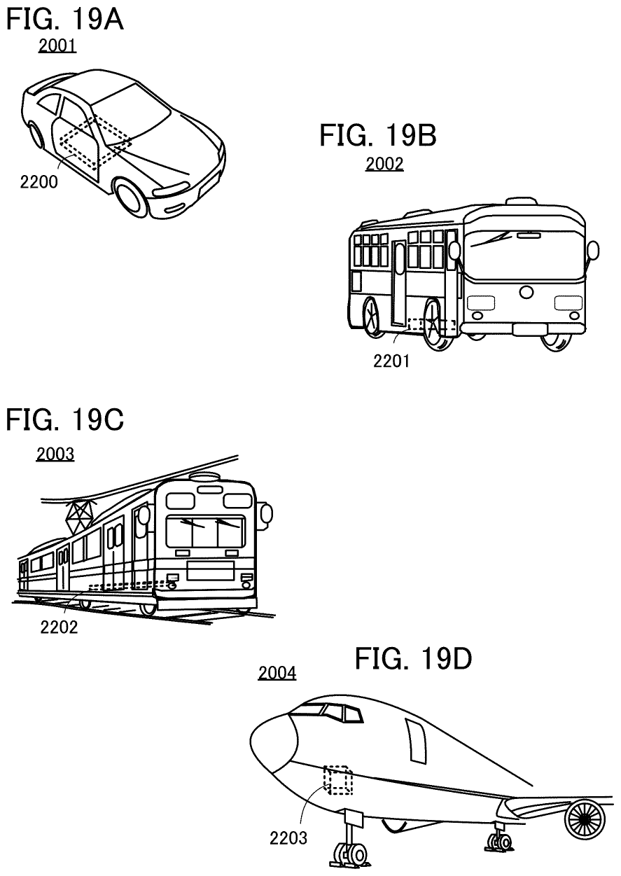

FIG. 19A to FIG. 19D show examples of transport vehicles using one embodiment of the present invention. An automobile 2001 illustrated in FIG. 19A is an electric vehicle that runs on an electric motor as a power source. Alternatively, the automobile 2001 is a hybrid vehicle that can appropriately select an electric motor or an engine as a driving power source. In the case where the secondary battery is mounted on the vehicle, an example of the secondary battery described in Embodiment 4 is provided at one position or several positions. The automobile 2001 illustrated in FIG. 19A includes a battery pack 2200, and the battery pack includes a secondary battery module in which a plurality of secondary batteries are connected to each other. Moreover, the battery pack preferably includes a charge control device that is electrically connected to the secondary battery module.

The automobile 2001 can be charged when the secondary battery included in the automobile 2001 is supplied with electric power from external charging equipment by a plug-in system, a contactless charging system, or the like. In charging, a given method such as CHAdeMO (registered trademark) or Combined Charging System may be employed as a charging method, the standard of a connector, and the like as appropriate. The secondary battery may be a charging station provided in a commerce facility or a household power supply. For example, with the use of the plug-in system, the power storage device mounted on the automobile 2001 can be charged by being supplied with electric power from the outside. Charging can be performed by converting AC power into DC power through a converter such as an ACDC converter.

Although not illustrated, the vehicle can include a power receiving device so as to be charged by being supplied with electric power from an above-ground power transmitting device in a contactless manner. For the contactless power feeding system, by fitting a power transmitting device in a road or an exterior wall, charging can be performed not only when the vehicle is stopped but also when driven. In addition, the contactless power feeding system may be utilized to perform transmission and reception of electric power between two vehicles. Furthermore, a solar cell may be provided in the exterior of the vehicle to charge the secondary battery when the vehicle stops or moves. To supply electric power in such a contactless manner, an electromagnetic induction method and/or a magnetic resonance method can be used.

FIG. 19B shows a large transporter 2002 having a motor controlled by electric power, as an example of a transport vehicle. The secondary battery module of the transporter 2002 has a cell unit of four secondary batteries with 3.5 V or higher and 4.7 V or lower, and 48 cells are connected in series to have 170 V as the maximum voltage. A battery pack 2201 has the same function as that in FIG. 19A except, for example, the number of secondary batteries configuring the secondary battery module; thus, the description is omitted.

FIG. 19C shows a large transport vehicle 2003 having a motor controlled by electricity as an example. The secondary battery module of the transport vehicle 2003 has 100 or more secondary batteries with 3.5 V or higher and 4.7 V or lower connected in series, and the maximum voltage is 600 V, for example. Thus, the secondary batteries are required to have few variations in the characteristics. By employing the positive electrode structure described in Embodiment 1, i.e., the structure including the fluorine-containing electrolyte in the positive electrode, and the positive electrode active material 811 obtained in Embodiment 2 for the positive electrode, a secondary battery having stable battery characteristics can be manufactured and mass production at low cost is possible in light of the yield. A battery pack 2202 has a function similar to that in FIG. 19A except that the number of secondary batteries forming the secondary battery module of the battery pack 2202 or the like is different; thus, the detailed description is omitted.

FIG. 19D shows an aircraft 2004 having a combustion engine as an example. The aircraft 2004 shown in FIG. 19D can be regarded as a kind of transport vehicles since it is provided with wheels for takeoff and landing, and has a battery pack 2203 including a secondary battery module and a charging control device; the secondary battery module includes a plurality of connected secondary batteries.

The secondary battery module of the aircraft 2004 has eight 4 V secondary batteries connected in series, which has the maximum voltage of 32 V, for example. The battery pack 2203 has the same function as that in FIG. 19A except, for example, the number of secondary batteries configuring the secondary battery module; thus, the description is omitted.

This embodiment can be implemented in appropriate combination with any of the other embodiments.

### Embodiment 5

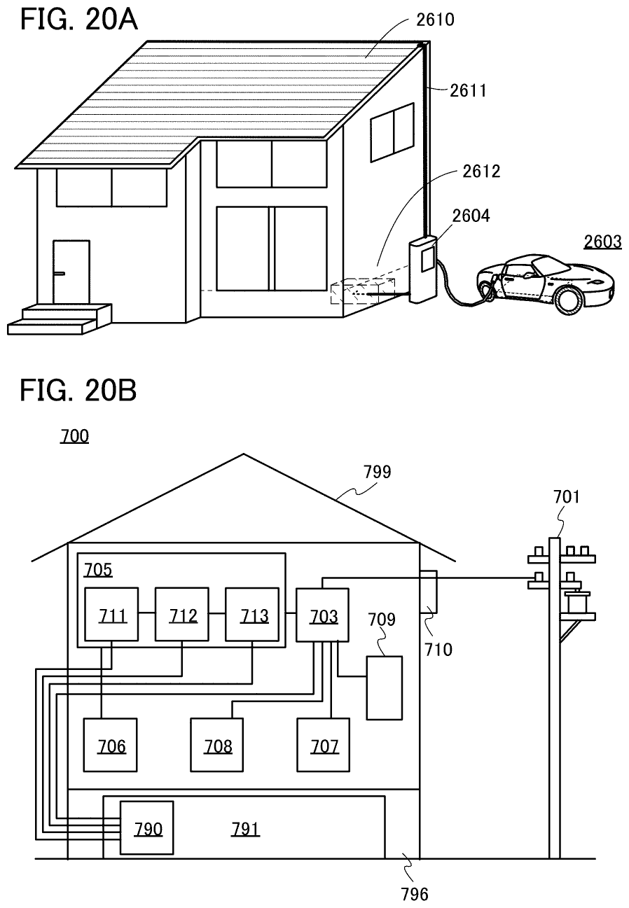

In this embodiment, examples in which the secondary battery of one embodiment of the present invention is mounted on a building are described with reference to FIG. 20A and FIG. 20B.

A house illustrated in FIG. 20A includes a power storage device 2612 including the secondary battery which is one embodiment of the present invention and a solar panel 2610. The power storage device 2612 is electrically connected to the solar panel 2610 through a wiring 2611 or the like. The power storage device 2612 may be electrically connected to ground-based charging equipment 2604. The power storage device 2612 can be charged with electric power generated by the solar panel 2610. A secondary battery included in a vehicle 2603 can be charged with the electric power stored in the power storage device 2612 through the charging equipment 2604. The power storage device 2612 is preferably provided in an underfloor space. The power storage device 2612 is provided in the underfloor space, in which case the space on the floor can be effectively used. Alternatively, the power storage device 2612 may be provided on the floor.

The electric power stored in the power storage device 2612 can also be supplied to other electronic devices in the house. Thus, with the use of the power storage device 2612 of one embodiment of the present invention as an uninterruptible power source, electronic devices can be used even when electric power cannot be supplied from a commercial power source due to power failure or the like.

FIG. 20B shows an example of a power storage device 700 of one embodiment of the present invention. As shown in FIG. 20B, a power storage device 791 of one embodiment of the present invention is provided in an underfloor space 796 of a building 799.

The power storage device 791 is provided with a control device 790, and the control device 790 is electrically connected to a distribution board 703, a power storage controller (also referred to as control device) 705, an indicator 706, and a router 709 through wirings.

Electric power is transmitted from a commercial power source 701 to the distribution board 703 through a service wire mounting portion 710. Moreover, electric power is transmitted to the distribution board 703 from the power storage device 791 and the commercial power source 701, and the distribution board 703 supplies the transmitted electric power to a general load 707 and a power storage load 708 through outlets (not shown).

The general load 707 is, for example, an electronic device such as a TV or a personal computer. The power storage load 708 is, for example, an electronic device such as a microwave, a refrigerator, or an air conditioner.

The power storage controller 705 includes a measuring portion 711, a predicting portion 712, and a planning portion 713. The measuring portion 711 has a function of measuring the amount of electric power consumed by the general load 707 and the power storage load 708 during a day (e.g., from midnight to midnight). The measuring portion 711 may have a function of measuring the amount of electric power of the power storage device 791 and the amount of electric power supplied from the commercial power source 701. The predicting portion 712 has a function of predicting, on the basis of the amount of electric power consumed by the general load 707 and the power storage load 708 during a given day, the demand for electric power consumed by the general load 707 and the power storage load 708 during the next day. The planning portion 713 has a function of making a charge and discharge plan of the power storage device 791 on the basis of the demand for electric power predicted by the predicting portion 712.

The amount of electric power consumed by the general load 707 and the power storage load 708 and measured by the measuring portion 711 can be checked with the indicator 706. It can be checked with an electronic device such as a TV or a personal computer through the router 709. Furthermore, it can be checked with a portable electronic terminal such as a smartphone or a tablet through the router 709. With the indicator 706, the electronic device, or the portable electronic terminal, for example, the demand for electric power depending on a time period (or per hour) that is predicted by the predicting portion 712 can be checked.

This embodiment can be implemented in appropriate combination with any of the other embodiments.

### Embodiment 6

In this embodiment, examples of electronic devices each including the secondary battery of one embodiment of the present invention are described. Examples of the electronic device including the secondary battery include a television device (also referred to as a television or a television receiver), a monitor of a computer and the like, a digital camera, a digital video camera, a digital photo frame, a mobile phone (also referred to as a cellular phone or a mobile phone device), a portable game console, a portable information terminal, an audio reproducing device, and a large-sized game machine such as a pachinko machine. Examples of the portable information terminal include a laptop personal computer, a tablet terminal, an e-book reader, and a mobile phone.

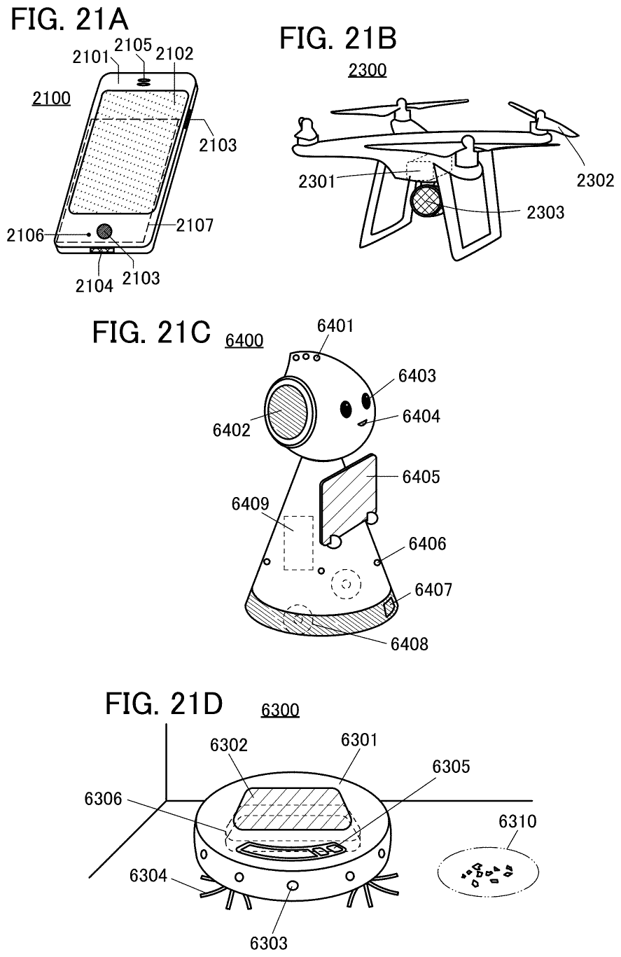

FIG. 21A shows an example of a mobile phone. A mobile phone 2100 includes a housing 2101 in which a display portion 2102 is incorporated, an operation button 2103, an external connection port 2104, a speaker 2105, a microphone 2106, and the like. The mobile phone 2100 includes a secondary battery 2107. When the second battery 2107 employing the positive electrode structure described in Embodiment 1, i.e., the structure including the fluorine-containing electrolyte in the positive electrode, and the positive electrode active material 811 described in Embodiment 2 for the positive electrode is used, high capacity and a structure that accommodates space saving due to a reduction in size of the housing can be achieved.

The mobile phone 2100 is capable of executing a variety of applications such as mobile phone calls, e-mailing, viewing and editing texts, music reproduction, Internet communication, and a computer game.

With the operation button 2103, a variety of functions such as time setting, power on/off, on/off of wireless communication, setting and cancellation of a silent mode, and setting and cancellation of a power saving mode can be performed. For example, the functions of the operation button 2103 can be set freely by the operating system incorporated in the mobile phone 2100.

In addition, the mobile phone 2100 can execute near field communication conformable to a communication standard. For example, mutual communication between the mobile phone 2100 and a headset capable of wireless communication can be performed, and thus hands-free calling is possible.

Moreover, the mobile phone 2100 includes the external connection port 2104, and data can be directly transmitted to and received from another information terminal via a connector. In addition, charging can be performed via the external connection port 2104. Note that the charging operation may be performed by wireless power feeding without using the external connection port 2104.

The mobile phone 2100 preferably includes a sensor. As the sensor, a human body sensor such as a fingerprint sensor, a pulse sensor, or a temperature sensor, a touch sensor, a pressure sensitive sensor, or an acceleration sensor is preferably mounted, for example.

FIG. 21B shows an unmanned aircraft 2300 including a plurality of rotors 2302. The unmanned aircraft 2300 is also referred to as a drone. The unmanned aircraft 2300 includes a secondary battery 2301 of one embodiment of the present invention, a camera 2303, and an antenna (not illustrated). The unmanned aircraft 2300 can be remotely controlled through the antenna. A secondary battery employing the positive electrode structure described in Embodiment 1, i.e., the structure including the fluorine-containing electrolyte in the positive electrode, and the positive electrode active material 811 obtained in Embodiment 2 for the positive electrode has a high energy density and a high degree of safety, and thus can be used safely for a long time over a long period of time and is suitable for the secondary battery included in the unmanned aircraft 2300.

FIG. 21C shows an example of a robot. A robot 6400 shown in FIG. 21C includes a secondary battery 6409, an illuminance sensor 6401, a microphone 6402, an upper camera 6403, a speaker 6404, a display portion 6405, a lower camera 6406, an obstacle sensor 6407, a moving mechanism 6408, an arithmetic device, and the like.

The microphone 6402 has a function of detecting a speaking voice of a user, an environmental sound, and the like. The speaker 6404 has a function of outputting sound. The robot 6400 can communicate with the user using the microphone 6402 and the speaker 6404.

The display portion 6405 has a function of displaying various kinds of information. The robot 6400 can display information desired by the user on the display portion 6405. The display portion 6405 may be provided with a touch panel. Moreover, the display portion 6405 may be a detachable information terminal, in which case charging and data communication can be performed when the display portion 6405 is set at the home position of the robot 6400.

The upper camera 6403 and the lower camera 6406 each have a function of taking an image of the surroundings of the robot 6400. The obstacle sensor 6407 can detect an obstacle in the direction where the robot 6400 advances with the moving mechanism 6408. The robot 6400 can move safely by recognizing the surroundings with the upper camera 6403, the lower camera 6406, and the obstacle sensor 6407.

The robot 6400 further includes, in its inner region, the secondary battery 6409 of one embodiment of the present invention and a semiconductor device or an electronic component. A secondary battery employing the positive electrode structure described in Embodiment 1, i.e., the structure including the fluorine-containing electrolyte in the positive electrode, and the positive electrode active material 811 obtained in Embodiment 2 for the positive electrode has high energy density and a high degree of safety, and thus can be used safely for a long time over a long period of time and is suitable as the secondary battery 6409 included in the robot 6400.

FIG. 21D shows an example of a cleaning robot. A cleaning robot 6300 includes a display portion 6302 placed on the top surface of a housing 6301, a plurality of cameras 6303 placed on the side surface of the housing 6301, a brush 6304, operation buttons 6305, a secondary battery 6306, a variety of sensors, and the like. Although not illustrated, the cleaning robot 6300 is provided with a tire, an inlet, and the like. The cleaning robot 6300 is self-propelled, detects dust 6310, and sucks up the dust through the inlet provided on the bottom surface.

For example, the cleaning robot 6300 can determine whether there is an obstacle such as a wall, furniture, or a step by analyzing images taken by the cameras 6303. In the case where the cleaning robot 6300 detects an object, such as a wire, that is likely to be caught in the brush 6304 by image analysis, the rotation of the brush 6304 can be stopped. The cleaning robot 6300 includes, in its inner region, the secondary battery 6306 of one embodiment of the present invention and a semiconductor device or an electronic component. A secondary battery employing the positive electrode structure described in Embodiment 1, i.e., the structure including the fluorine-containing electrolyte in the positive electrode, and the positive electrode active material 811 obtained in Embodiment 2 for the positive electrode has high energy density and a high degree of safety, and thus can be used safely for a long time over a long period of time and is suitable for the secondary battery 6306 included in the cleaning robot 6300.

This embodiment can be implemented in appropriate combination with any of the other embodiments.

### Example 1

In this example, coin-type battery cells were fabricated and subjected to a 1 C cycle test at 85° C.

Samples fabricated in this example are described. Two samples were fabricated under the same conditions and through the same steps.

As a positive electrode active material for each sample, a lithium nickel-cobalt-manganese oxide (NCM523) which is produced by MTI corporation and has a ratio of nickel to cobalt to manganese Ni:Co:Mn=5:2:3 was used.

Using formed positive electrodes, CR2032 type coin-type battery cells (a diameter of 20 mm, a height of 3.2 mm) were fabricated.

A lithium metal was used for a counter electrode.

As an electrolyte for each sample, 1 mol/L lithium hexafluorophosphate (LiPF₆) was used, and monofluoroethylene carbonate (FEC), ethyl methyl carbonate (EMC), and dimethyl carbonate (DMC) were mixed at FEC:EMC:DMC=3:3.5:3.5 (volume ratio).

As a separator, 25-μm-thick polypropylene was used.

A positive electrode can and a negative electrode can that were formed using stainless steel (SUS) were used.

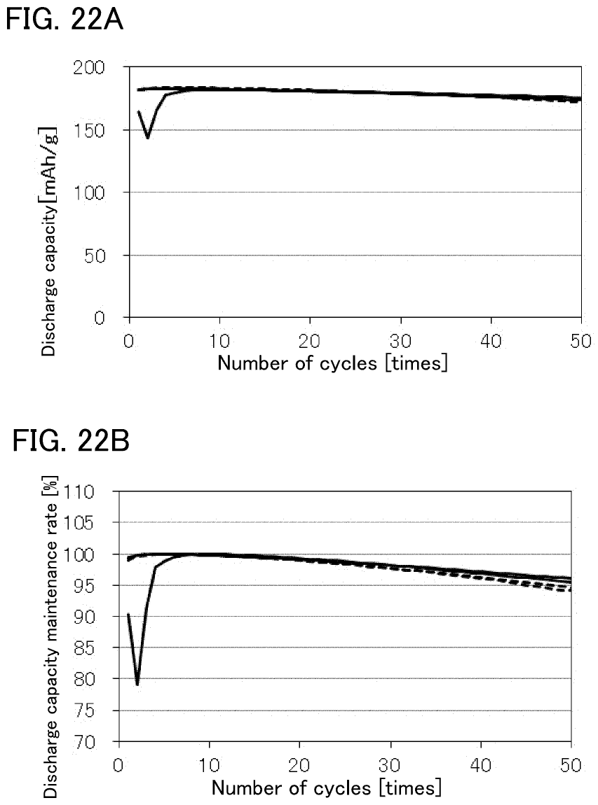

FIG. 22A shows the result of a 1 C cycle test of the sample 1 at 85° C. In the cycle test, the CCCV charge was performed (1 C, 4.3 V, and a termination current of 0.1 C) and the CC discharge was performed (1 C, 2.5 V).

FIG. 22B is a graph with the vertical axis representing the capacity maintenance rate.

It can be found from these results that the cycle performance at 85° C. is favorable when a fluorine-containing compound is used as the electrolyte.

It was confirmed from the above results that use of the electrolyte of one embodiment of the present invention enables use in a wide temperature range, specifically, use at 85° C. Accordingly, a vehicle including the secondary battery of one embodiment of the present invention can be driven with the use of the secondary battery as a power source even when the temperature outside the vehicle is higher than or equal to 25° C. and lower than or equal to 85° C.

### REFERENCE NUMERALS

10: positive electrode current collector, 11: negative electrode current collector, 102: space in heating furnace, 104: hot plate, 106: heater unit, 108: heat insulator, 116: container, 118: lid, 119: space, 120: heating furnace, 201: electrode, 202: graphene, 204: hole, 300: secondary battery, 301: positive electrode can, 302: negative electrode can, 303: gasket, 304: positive electrode, 305: positive electrode current collector, 306: positive electrode active material layer, 307: negative electrode, 308: negative electrode current collector, 309: negative electrode active material layer, 310: separator, 312: washer, 313: ring-shaped insulator, 322: spacer, 500: secondary battery, 501: positive electrode current collector, 502: positive electrode active material layer, 503: positive electrode, 504: negative electrode current collector, 505: negative electrode active material layer, 506: negative electrode, 507: separator, 508: electrolyte, 509: exterior body, 510: positive electrode lead electrode, 511: negative electrode lead electrode, 550: current collector, 551: active material, 553: acetylene black, 554: graphene, 555: carbon nanotube, 556: region, 561: active material, 562: active material, 601: positive electrode cap, 602: battery can, 603: positive electrode terminal, 604: positive electrode, 605: separator, 606: negative electrode, 607: negative electrode terminal, 608: insulating plate, 609: insulating plate, 611: PTC element, 613: safety valve mechanism, 614: conductive plate, 615: power storage system, 616: secondary battery, 620: control circuit, 621: wiring, 622: wiring, 623: wiring, 624: conductor, 625: insulator, 626: wiring, 627: wiring, 628: conductive plate, 700: power storage device, 701: commercial power source, 703: distribution board, 705: power storage controller, 706: indicator, 707: general load, 708: power storage load, 709: router, 710: service wire mounting portion, 711: measuring portion, 712: predicting portion, 713: planning portion, 790: control device, 791: power storage device, 796: underfloor space, 799: building, 801: composite oxide, 802: fluoride, 803: compound, 804: mixture, 805: mixture, 806: mixture, 807: lithium compound, 810: mixture, 811: positive electrode active material, 911a: terminal, 911b: terminal, 913: secondary battery, 930: housing, 930a: housing, 930b: housing, 931: negative electrode, 931a: negative electrode active material layer, 932: positive electrode, 932a: positive electrode active material layer, 933: separator, 950: wound body, 950a: wound body, 951: terminal, 952: terminal, 1000: secondary battery, 1001: positive electrode current collector, 1002: positive electrode active material layer, 1003: electrolyte layer, 1004: negative electrode active material layer, 1005: negative electrode current collector, 1006: positive electrode, 1007: negative electrode, 1010: region, 1011: positive electrode active material, 1300: rectangular secondary battery, 1301a: battery, 1301b: battery, 1302: battery controller, 1303: motor controller, 1304: motor, 1305: gear, 1306: DC-DC circuit, 1307: electric power steering, 1308: heater, 1309: defogger, 1310: DC-DC circuit, 1311: battery, 1312: inverter, 1313: audio, 1314: power window, 1315: lamps, 1316: tire, 1317: rear motor, 1320: control circuit portion, 1321: control circuit portion, 1322: control circuit, 1324: switch portion, 1325: external terminal, 1326: external terminal, 1413: fixing portion, 1414: fixing portion, 1415: battery pack, 1421: wiring, 1422: wiring, 2001: automobile, 2002: transporter, 2003: transport vehicle, 2004: aircraft, 2100: mobile phone, 2101: housing, 2102: display portion, 2103: operation button, 2104: external connection port, 2105: speaker, 2106: microphone, 2107: secondary battery, 2200: battery pack, 2201: battery pack, 2202: battery pack, 2203: battery pack, 2300: unmanned aircraft, 2301: secondary battery, 2302: rotor, 2303: camera, 2603: vehicle, 2604: charging equipment, 2610: solar panel, 2611: wiring, 2612: power storage device, 6300: cleaning robot, 6301: housing, 6302: display portion, 6303: camera, 6304: brush, 6305: operation button, 6306: secondary battery, 6310: dust, 6400: robot, 6401: illuminance sensor, 6402: microphone, 6403: upper camera, 6404: speaker, 6405: display portion, 6406: lower camera, 6407: obstacle sensor, 6408: moving mechanism, 6409: secondary battery.

1. A secondary battery comprising:
a positive electrode; and
a negative electrode,
wherein the positive electrode comprises a fluorine-containing electrolyte, a current collector, a positive electrode active material, and a binder.

2. The secondary battery according to claim 1,
wherein the positive electrode further comprises a solid electrolyte material, and
wherein the solid electrolyte material is an oxide.

3. The secondary battery according to claim 1,
wherein the positive electrode further comprises graphene.

4. The secondary battery according to claim 1, comprising different electrolytes.

5. The secondary battery according to claim 1,
wherein the positive electrode active material comprises fluorine.

6. The secondary battery according to claim 1,
wherein the negative electrode comprises silicon.

7. The secondary battery according to claim 1,
wherein the negative electrode comprises graphene.

8. The secondary battery according to claim 1,
wherein the negative electrode comprises fluorine.

9. The secondary battery according to claim 1,
wherein the secondary battery is a semi-solid-state secondary battery.

10. A vehicle comprising the secondary battery according to claim 1.

11. The secondary battery according to claim 1,
wherein the negative electrode comprises a carbon-based material containing fluorine.

12. The secondary battery according to claim 11,
wherein the concentration of fluorine is higher than or equal to 1 atomic % with respect to the total concentration of fluorine, oxygen, lithium, and carbon when the carbon-based material is measurement by X-ray photoelectron spectroscopy.

13. The secondary battery according to claim 1,
wherein the negative electrode comprises a conductive agent modified with fluorine.
